(19) United States
(12) Patent Application Publication
(10) Pub. No.: US 2023/0409699 A1
(43) Pub. Date: Dec. 21, 2023

(54) METHOD FOR ADDING SECURITY FEATURES TO SGX VIA PATCH ON PLATFORMS THAT SUPPORT PATCH ROLLBACK

(71) Applicant: Intel Corporation, Santa Clara, CA (US)

(72) Inventors: Scott CONSTABLE, Portland, OR (US); Ilya ALEXANDROVICH, Yokneam Illit (IL); Ittai ANATI, Ramat Hasharon (IL); Simon JOHNSON, Beaverton, OR (US); Vincent SCARLATA, Beaverton, OR (US); Mona VIJ, Hillsboro, OR (US); Yuan XIAO, Columbus, OH (US); Bin XING, Hillsboro, OR (US); Krystof SMUDZINSKI, Forest Grove, OR (US)

(21) Appl. No.: 17/948,829

(22) Filed: Sep. 20, 2022

Related U.S. Application Data
(60) Provisional application No. 63/353,301, filed on Jun. 17, 2022.

(51) Int. Cl. G06F 21/53

(52) U.S. Cl. CPC G06F 21/53; G06F 2221/034

(57) ABSTRACT

Detailed herein are examples of determining when to allow access to a trusted execution environment (TEE). For example, using TEE logic associated with software to at least in part: determine that a TEE feature is supported based at least on a value of a bit position in a data structure; and not allow a TEE entry instruction to access to a TEE when the bit position of the data structure is reserved.

### BACKGROUND

A processor, or set of processors, executes instructions from an instruction set, e.g., the instruction set architecture (ISA). The ISA is the part of the computer architecture related to programming, and generally may include the native data types, instructions, register architecture, addressing modes, memory architecture, interrupt and exception handling, and external input and output (I/O) architecture. It should be noted that the term instruction herein may refer to a macro-instruction, e.g., an instruction that is provided to the processor for execution, or to a micro-instruction, e.g., an instruction that results from a processor's decoder decoding macro-instructions.

### BRIEF DESCRIPTION OF DRAWINGS

Various examples in accordance with the present disclosure will be described with reference to the drawings.

FIG. 1 illustrates a system in which embodiments may be implemented.

FIG. 2A illustrates aspects of embodiments in a method for handling an exception (or other EEE) within a TEE, using a CHGCTX instruction.

FIG. 2B illustrates aspects of embodiments in a method for handling an exception (or other EEE) within an SGX secure enclave, using a CHGCTX instruction.

FIG. 2C illustrates aspects of embodiments in a method for handling an exception (or other EEE) within a TEE, using a CHGCTX instruction, to mitigate potential side channel attacks.

FIG. 3 illustrates a thread control structure 127 and state save area (SSA) stack 302 according to embodiments of the disclosure.

FIG. 4 illustrates how AEX Notify can allow enclaves to handle exceptions more efficiently, without requiring an additional EENTER and EEXIT according to some examples.

FIG. 5 illustrates examples of SECS.

FIG. 6 illustrates examples of an attributes field of SECS.

FIG. 7 illustrates examples of TCS and TCS.FLAGS.

FIG. 8 illustrates examples of a SSA frame.

FIG. 9 illustrates examples of SSA.GPRSGX.

FIG. 10 illustrates examples of formats for EDECCSSA.

FIG. 11 illustrates examples of handling an attempt by software to enter a TEE.

FIG. 12 illustrates examples of untrusted software (e.g., an OS or application) handling an attempt to enter a TEE.

FIG. 13 illustrates an example computing system.

FIG. 14 illustrates a block diagram of an example processor and/or System on a Chip (SoC) that may have one or more cores and an integrated memory controller.

FIG. 15(A) is a block diagram illustrating both an example in-order pipeline and an example register renaming, out-of-order issue/execution pipeline according to examples.

FIG. 15(B) is a block diagram illustrating both an example in-order architecture core and an example register renaming, out-of-order issue/execution architecture core to be included in a processor according to examples.

FIG. 16 illustrates examples of execution unit(s) circuitry.

FIG. 17 is a block diagram of a register architecture according to some examples.

FIG. 18 illustrates examples of an instruction format.

FIG. 19 illustrates examples of an addressing information field.

FIG. 20 illustrates examples of a first prefix.

FIGS. 21(A)-(D) illustrate examples of how the R, X, and B fields of the first prefix in FIG. 20 are used.

FIGS. 22(A)-(B) illustrate examples of a second prefix.

FIG. 23 illustrates examples of a third prefix.

FIG. 24 is a block diagram illustrating the use of a software instruction converter to convert binary instructions in a source instruction set architecture to binary instructions in a target instruction set architecture according to examples.

### DETAILED DESCRIPTION

In the following description, numerous specific details are set forth. However, it is understood that embodiments of the disclosure may be practiced without these specific details. In other instances, well-known circuits, structures, and techniques have not been shown in detail in order not to obscure the understanding of this description.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

As used in this specification and the claims and unless otherwise specified, the use of the ordinal adjectives “first,” “second,” “third,” etc. to describe an element merely indicates that a particular instance of an element or different instances of like elements are being referred to, and is not intended to imply that the elements so described must be in a particular sequence, either temporally, spatially, in ranking, or in any other manner. Also, as used in descriptions of embodiments, a “I” character between terms may mean that what is described may include or be implemented using, with, and/or according to the first term and/or the second term (and/or any other additional terms).

Also, the terms “bit,” “flag,” “field,” “entry,” “indicator,” etc., may be used to describe any type or content of a storage location in a register, table, database, or other data structure, whether implemented in hardware or software, but are not meant to limit embodiments to any particular type of storage location or number of bits or other elements within any particular storage location. For example, the term “bit” may be used to refer to a bit position within a register and/or data stored or to be stored in that bit position. The term “clear” may be used to indicate storing or otherwise causing the logical value of zero to be stored in a storage location, and the term “set” may be used to indicate storing or otherwise causing the logical value of one, all ones, or some other specified value to be stored in a storage location; however, these terms are not meant to limit embodiments to any particular logical convention, as any logical convention may be used within embodiments.

An information processing system, a central processing unit (CPU) or other processor within an information processing system, and/or an execution or processing core within a CPU or processor may support a trusted execution environment (TEE), for example, by implementing an architecturally protected execution environment. In some embodiments, a trusted execution environment may use one or more protected containers in memory, e.g., one or more architecturally protected enclaves. In this description, the term “enclave” may be used to refer to any execution environment that is trusted, protected, secure, etc. or any container within such an execution environment, and is not limited to a secure enclave as may be described below as an example.

In some embodiments, an instruction set architecture (ISA) or extension(s) of an ISA (e.g., Intel® Software Guard Extensions (Intel® SGX)) includes a set of instructions and mechanisms for memory accesses by a processor. For example, a first set of instruction extensions (e.g., SGX1) allows an application to instantiate a protected container (e.g., an enclave). In one embodiment, an enclave is a protected area in the application's address space, e.g., which provides confidentiality and integrity even in the presence of malware operating at a higher privilege level. In some embodiments, accesses to the enclave (e.g., its memory area) from any software not resident in the enclave are prevented. In embodiments, a second set of instruction extensions (e.g., SGX2) allows additional flexibility in runtime management of enclave resources and thread execution within an enclave.

TEEs are designed to provide confidentiality and integrity guarantees to facilitate secure code execution within an untrusted environment, such as a machine owned by a cloud service provider. Some TEEs—including Intel® SGX—are designed to run within a process, and therefore must be able to satisfy the same set of functional requirements as a non-TEE process. One such requirement is the ability to handle runtime exceptions and other asynchronous and synchronous events, such as exceptions, interrupts (e.g., external interrupts, non-markable interrupts, system-management interrupts), traps, and virtual machine (VM) exits (as well as signals associated with such events) that may occur while executing inside an enclave. to protect the integrity and security of the enclave, some processors will exit the enclave (e.g., and enclave mode) before invoking the handler for such an event. For that reason, such events may be called enclave-exiting events (EEEs).

An example of an EEE is an exception triggered when software running within a TEE attempts to invoke certain instructions that may be illegal (e.g., CPUID or SYSCALL), unsupported or having an undefined opcode (e.g., triggering a #UD exception that the OS turns into a signal), etc. within enclaves.

In some embodiments, EEEs may also include signals associated with software and/or hardware triggered exceptions and/or events that privileged system software (e.g., an operating system (OS)) allows unprivileged user-level software (e.g., an application) to handle. For example, the OS may allow an application to register a user-space handler or function to be invoked by the OS if a specified event (e.g., a signal) is sent to the application.

When TEEs were first commoditized, the scope of software expected to run within a TEE was mostly limited to programs/libraries written specifically for that TEE. It would have been atypical for such software to encounter many exceptions, and therefore the architectural exception handling model for these TEEs was never optimized. However, in recent years the proliferation of containerization/native-compatibility frameworks such as Graphene-SGX, Gramine-SGX, and SCONE have dramatically broadened the scope of software that can run inside of a TEE to include software that was never intended to run inside of a TEE. This new software architecture requires significantly more emulation, dynamic memory management, etc. than TEEs such as Intel SGX were designed to support; hence the unoptimized exception handling behavior of commodity TEEs has become a bottleneck for performance.

Furthermore, recent developments on potential side-channel attacks have made it desirable to have a mechanism to detect and handle events that would cause a TEE to exit asynchronously, including both exceptions and interrupts.

An existing approach to handling an exception within a TEE may include entering, exiting, re-entering, exiting, and re-entering the TEE, as follows:

Enter the TEE in a particular context (call this the main context) to perform an operation. The context may consist of general-purpose register (GPR) values, model specific register (MSR) values, vector register values, etc.

While performing the operation, the TEE software encounters an exception and exits. This process may be referred to as an asynchronous enclave exit (AEX) and is further described below. The TEE is re-entered in a different context (call this the handler context) to handle the exception.

The exception handler can examine and modify the saved main context to diagnose and resolve the exception.
If the exception cannot be resolved, the TEE will shut down.
If the exception has been resolved, continue.
The TEE software running in the exception context exits.
The TEE is re-entered and the main context is restored from the context save area.
Execution may continue.

The AEX process may include saving the main context within a reserved area of the TEE to preserve its integrity and confidentiality. This reserved area may be called a save area, a context save area, a context state save area, or a state save area (SSA), and each context may have its own designated SSA. An asynchronous exit pointer (AEP) to the location of the eventing address may be pushed onto the stack, e.g., as the location to where control will return after executing a return or return from interrupt (e.g., IRET) instruction. An instruction to resume execution within the enclave (e.g., an ERESUME instruction, an SGX leaf function) may be executed from that point to reenter the enclave and resume execution from the interrupted point.

Repeated saving and restoring of TEE state may have a significant impact on performance; therefore, embodiments may provide efficient handling of exceptions, interrupts, signals, and other EEEs in TEEs for improved performance by reducing the number of TEE exits and entries associated with handling EEEs. Embodiments may include use of a new instruction to atomically switch to a different execution context within a TEE, without requiring software to exit and then re-enter the TEE to perform some context switches, thus expediting exception and some other EEE/AEX handling.

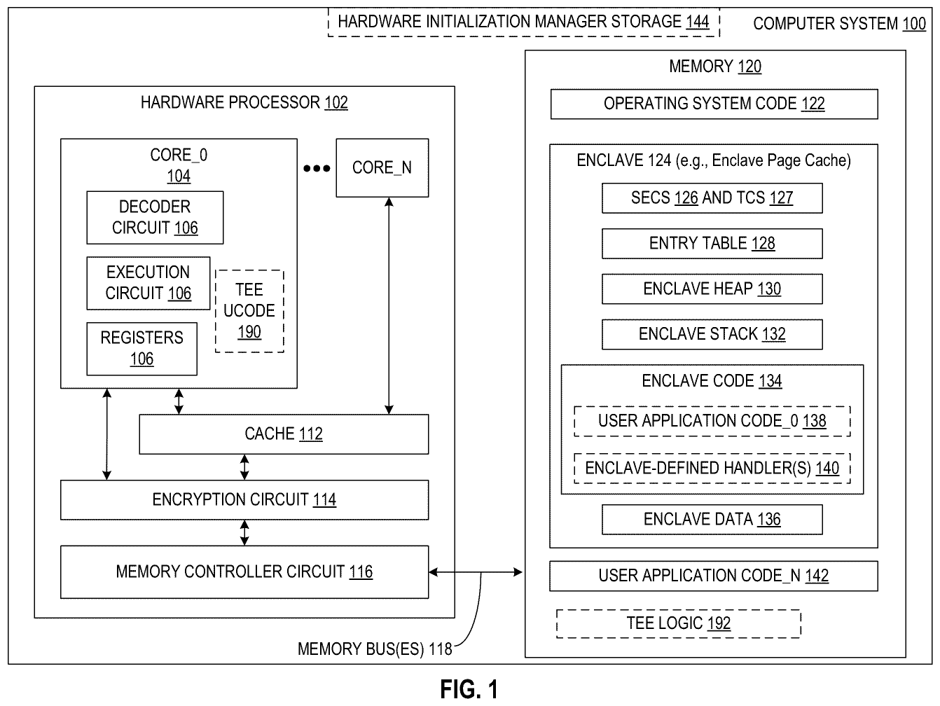

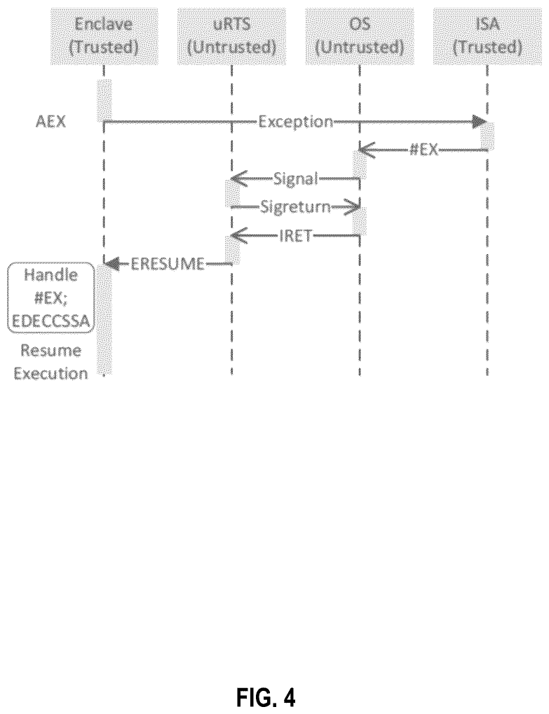

FIG. 1 illustrates a system 100 in which embodiments may be implemented. System 100 includes a hardware processor 102 coupled to a memory 120 having an enclave 124 according to embodiments. Hardware processor 102 may include any number of cores (e.g., core_0 only, core_0 and core_1, core_0 to core_N (where N is any positive integer), etc.), where a core may be any hardware processor or execution core, e.g., an instance of core 490 in FIG. 4. Depicted core 104 includes a decoder circuit 106 to decode instructions into decoded instructions and an execution circuit 108 to execute instructions, e.g., to operate on data in registers 110 and/or memory 120.

The blocks shown in hardware processor 102 may be implemented in logic gates and/or any other type of circuitry, all or parts of which may be integrated into the circuitry of a processing device or any other apparatus in a computer or other information processing system.

Memory access (e.g., store or load) request may be generated by a core, e.g., a memory access request may be generated by execution circuit 108 of core 104 (e.g., caused by the execution of an instruction decoded by decoder circuit 106). In some embodiments, a memory access request is serviced by a cache, e.g., one or more levels of cache 112 in hardware processor 102. Additionally, or alternatively (e.g., for a cache miss), a memory access request may be serviced by memory separate from a cache.

In some embodiments, computer system 100 includes an encryption circuit 114. In one embodiment, encryption circuit 114 of hardware processor 102 receives a memory access (e.g., store or load) request from one or more of its cores (e.g., from an address generation circuit of execution circuit 108). Encryption circuit may, e.g., for an input of a destination address and text to be encrypted (e.g., plaintext) (e.g., and a key), perform an encryption to generate a ciphertext (e.g., encrypted data). The ciphertext may then be stored in storage, e.g., in memory 120. An encryption circuit may perform a decryption operation, e.g., for a memory load request.

In some embodiments, computer system 100 includes a memory controller circuit. In one embodiment, memory controller circuit 116 of hardware processor 102 receives an address for a memory access request, e.g., and for a store request also receiving the payload data (e.g., ciphertext) to be stored at the address, and then performs the corresponding access into memory 120, e.g., via one or more memory buses 118. Computer system 100 may also include a coupling to secondary (e.g., external) memory (e.g., not directly accessible by a processor), for example, a disk (or solid state) drive.

In one embodiment, the hardware initialization manager (non-transitory) storage 144 stores hardware initialization manager firmware (e.g., or software). In one embodiment, the hardware initialization manager (non-transitory) storage 144 stores Basic Input/Output System (BIOS) firmware. In another embodiment, the hardware initialization manager (non-transitory) storage 144 stores Unified Extensible Firmware Interface (UEFI) firmware. In some embodiments (e.g., triggered by the power-on or reboot of a processor), computer system 100 (e.g., core 104) executes the hardware initialization manager firmware (e.g., or software) stored in hardware initialization manager (non-transitory) storage 144 to initialize the system 100 for operation, for example, to begin executing an operating system (OS), initialize and test the (e.g., hardware) components of system 100, and/or enabling enclave functionality (e.g., enclave instructions) (e.g., enabling by setting a corresponding field in a control register (e.g., model-specific register (MSR)) of registers 110, e.g., IA32_FEATURE_CONTROL MSR).

Memory 120 may store operating system (OS) code 122 (e.g., supervisor level code, e.g., current privilege level (CPL)=0). For example, with the current privilege level stored in a current privilege level (CPL) field of a code segment selector register of segment register of registers 110. Memory 120 may store user application code (e.g., user code_0 138 to user code_N 142) (e.g., user level code, e.g., CPL >0 ). However, in some embodiments it is desirable to store user application code (e.g., user code_0 138) within an enclave 124.

Enclave 124 may include a secure enclave control structure (SECS) (e.g., with one SECS per enclave) 126 and/or thread control structure (TCS) 127 (e.g., one TCS for each thread), an entry table 128, an enclave heap 130, an enclave stack 132, enclave code 134 (e.g., user application code_0 138 (e.g., a user application) and/or an enclave defined handler 140), enclave data 136 (e.g., to store encrypted data used by user application code_0 128), or any one or combination thereof. In some embodiments, a SECS contains meta-data about the enclave which is used by the hardware and cannot be directly accessed by software. For example, a SECS including a field that stores the enclave build measurement value (e.g., MRENCLAVE). In one embodiment, that field is initialized by executing an enclave create (ECREATE) instruction, e.g., and updated by every enclave add (EADD) instruction and enclave extend (EEXTEND) instruction and/or locked by an enclave initialize (EINIT) instruction.

In some embodiments, every enclave contains one or more TCS structures, e.g., per thread of the enclave. For example, with a TCS containing meta-data used by the hardware to save and restore thread specific information when entering/exiting the enclave. In one embodiment, there is only one field (e.g., FLAGS) of a TCS that may be accessed by software (e.g., where this field can only be accessed by debug enclaves). In one embodiment, a flag bit (e.g., DBGOPTIN) allows a single step into the thread associated with the TCS. In some embodiments, a SECS is created when an ECREATE instruction is executed. In some embodiments, a TCS may be created using an EADD instruction and/or an (e.g., SGX2) instruction. In some embodiments, TCSs may be aligned on 4KByte boundaries.

An enclave 124 may include one or more pages of an enclave page cache (EPC), e.g., where the EPC is the secure storage used to store enclave pages when they are a part of an executing enclave. In some embodiments, for an EPC page, hardware performs additional access control checks to restrict access to the page, e.g., after the current page access checks and translations are performed, the hardware checks that the EPC page is accessible to the program currently executing. In one embodiment, generally an EPC page is only accessed by the owner of the executing enclave or an instruction which is setting up an EPC page. In some embodiments, an EPC is divided into EPC pages, e.g., where an EPC page is 4KB in size and always aligned on a 4KB boundary. In some embodiments, pages in the EPC can either be valid or invalid, e.g., where every valid page in the EPC belongs to one enclave instance. In some embodiments, the EPC is managed by privileged software (e.g., OS or VMM). Some embodiments include an ISA extension or a set of instructions for adding and removing content to and from the EPC. The EPC may be configured by a hardware initialization manager at boot time. In one implementation in which EPC memory is part of system memory (e.g., dynamic random-access memory (DRAM)), the contents of the EPC are protected by encryption circuit 114.

TEE microcode 190 and/or TEE logic 192 (e.g., TEE logic software in memory) are responsible for handling TEEs including tracking rollbacks, etc. as needed.

Enclave instructions may include supervisor-level instructions and user-level instructions.

Examples of supervisor-level enclave instructions are an enclave add (EADD) instruction to add an EPC page to an enclave, an enclave block (EBLOCK) instruction to block an EPC page, an enclave create (ECREATE) instruction to create an enclave, a debug enclave read (EDBGRD) instruction to read data from a debug enclave by a debugger, a debug enclave write (EDBGWR) instruction to read data from a debug enclave by a debugger, an enclave extend (EEXTEND) instruction to extend an EPC page measurement, an enclave initialize (EINIT) instruction to initialize an enclave, an enclave load blocked (ELDB) instruction to load an EPC page in a blocked state, an enclave load unblocked (ELDU) instruction to load an EPC page in an unblocked state, an enclave PA (EPA) instruction to add an EPC page to create a version array, an enclave remove (EREMOVE) instruction to remove an EPC page from an enclave, an enclave track (ETRACK) instruction to activate enclave block (EBLOCK) checks, or an enclave write back/invalidate (EWB) instruction to write back and invalidate an EPC page.

Examples of user-level enclave instructions are an enclave enter (EENTER) instruction to enter an enclave, an enclave exit (EEXIT) instruction to exit an enclave, an enclave key (EGETKEY) instruction to create a cryptographic key, an enclave report (EREPORT) instruction to create a cryptographic report, or an enclave resume (ERESUME) instruction to re-enter an enclave.

Embodiments may include use of a new enclave instruction to atomically switch to a different execution context within a TEE, without requiring software to exit and then re-enter the TEE to perform some context switches, thus expediting exception and some other EEE/AEX handling. In this description, this instruction may be referred to as a change context instruction, CHGCTX, or a CHGCTX instruction. Any description using those terms may be implemented with one or more other instruction name(s), as embodiments may be implemented with any instruction name(s) (e.g., DECCSSA, EDECCSSA). Embodiments may include more than one such instruction (or leaves of an instruction) with more than one name (or distinguished by an operand, immediate, prefix, suffix, etc.), for example, a first instruction the operation of which causes a change to a context index (e.g., as described below) and a second instruction that does not.

In embodiments, a processor may perform one or more operations in response to a CHGCTX instruction (e.g., to execute or otherwise respond to a decoded CHGCTX instruction and/or micro-operations/micro-instructions decoded from a CHGCTX instruction). These operations may include one or more operations to save/store state of the context from which the CHGCTX instruction was invoked (e.g., the handler context in method 200) and one or more operations to load/restore state of the context to be entered (e.g., the main context in method 200).

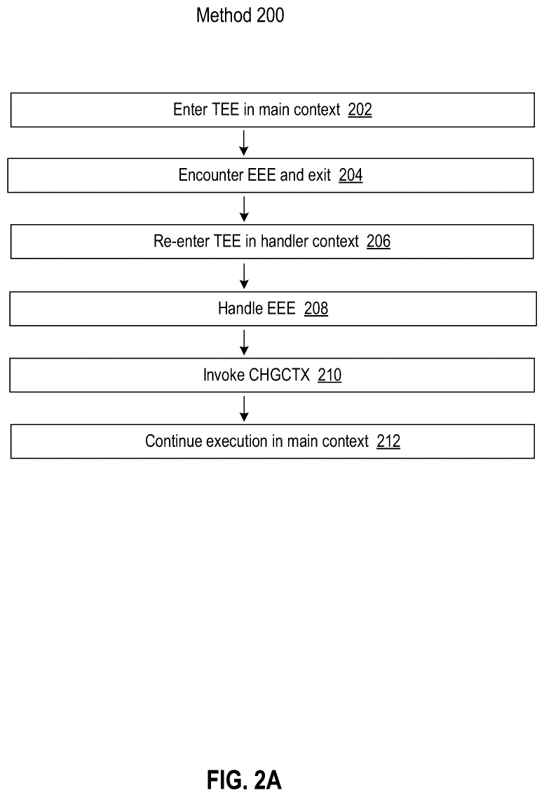

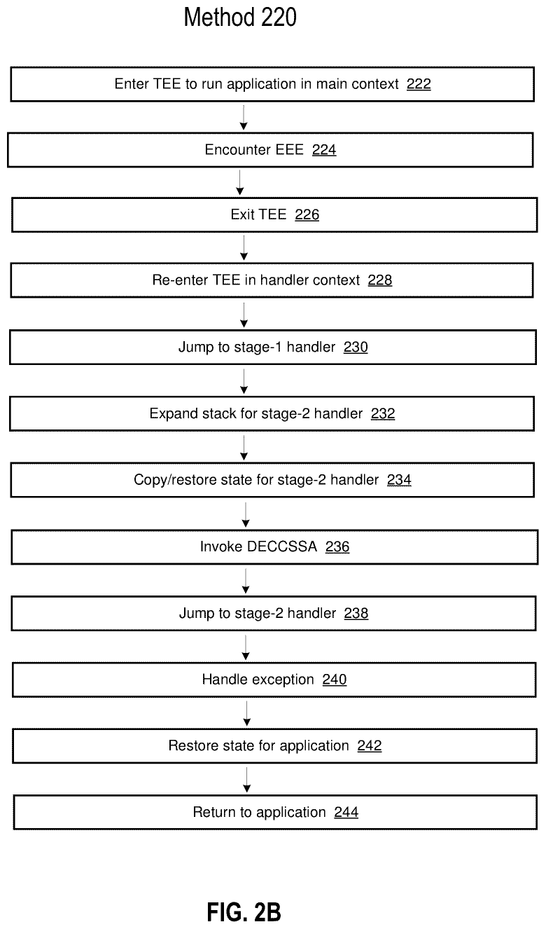

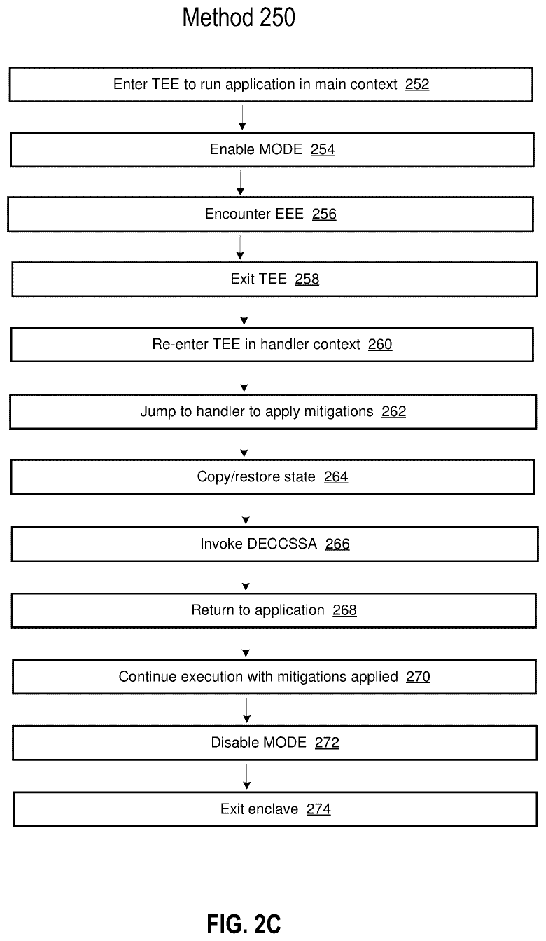

FIG. 2A illustrates aspects of embodiments in a method 200 for handling an exception (or other EEE) within a TEE, using a CHGCTX instruction. In method 200 (as well as the methods illustrated in FIGS. 2B and 2C), the TEE may be created and/or maintained by hardware/firmware/microcode of a processor (e.g., processor 102), in full or in part in response to the invocation of instructions by software.

Method 200 includes, in block 202, entering a TEE in the main context to perform an operation. The context may consist of general-purpose register (GPR) values, model specific register (MSR) values, vector register values, etc.

In block 204, while performing the operation within the TEE, the TEE software encounters an exception and the TEE is exited (e.g., automatically by operation of the processor hardware/firmware/microcode (HW/FW/ucode)). The exit process includes saving the main context within the main context's SSA, as described below.

In block 206, the TEE is re-entered (e.g., in response to an EENTER or ERESUME instruction) in a different context (call this context the handler context) to handle the exception.

In block 208, the exception handler, executing within the TEE, examines and possibly modifies the main context to diagnose and resolve the exception, if possible. If the exception can be resolved, method 200 continues to block 210; if not, the TEE shuts down (not shown in FIG. 2A).

In block 210, the exception handler invokes CHGCTX to exit the handler context and enter the main context, all within the TEE (i.e., without exiting the TEE).

In block 212, execution continues in the main context within the TEE.

An embodiment as shown in FIG. 2A may include only one TEE exit and one TEE re-entry (not including the initial entry in block 202), compared to two TEE exits and TEE re-entries (not including the initial entry) according to the existing approach described above.

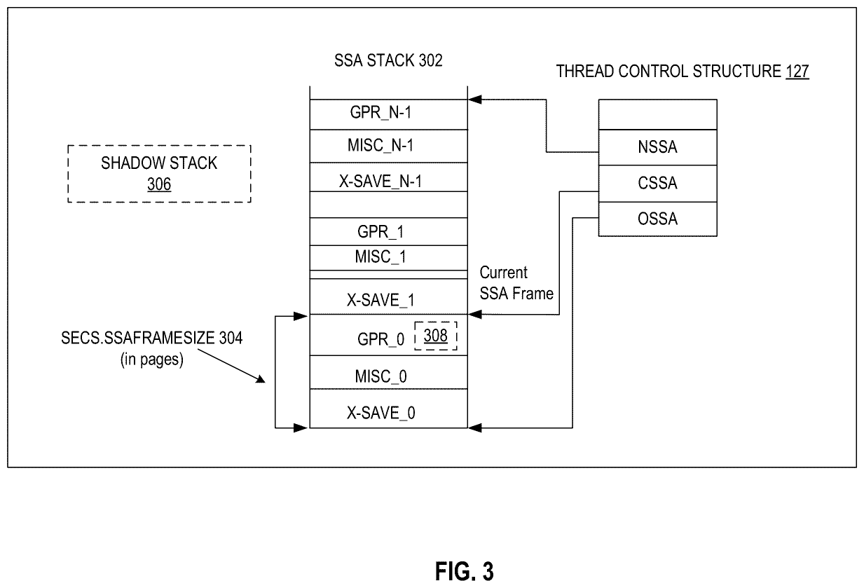

To protect the secrecy of the enclave, in some embodiments an AEX or enclave exit (as in block 204) saves the state of certain registers within enclave memory (e.g., SSA) and then loads those registers with fixed values (e.g., called synthetic state). In some embodiments, the state save area holds the processor state at the time of an AEX. To allow handling events within the enclave and re-entering it after an AEX, in some embodiments the SSA is a stack of multiple SSA frames, e.g., as shown in FIG. 3.

For example, each enclave may be associated with a SECS 126 and each executing thread in an enclave may be associated with a TCS 127. A SECS 126 may have one or more fields, including a field to indicate a frame size for an SSA. A TCS 127 may have one or more fields, including fields to indicate parameters of one or more SSAs for the associated thread. In an embodiment, the one or more SSAs may be saved in an SSA stack, and the SSA fields may include:
OSSA to store an offset, from the enclave's base address, of the base address of the SSA stack
CSSA to store an index of a slot of the current SSA frame
NSSA to store the number of slots available for SSA frames

FIG. 3 illustrates a thread control structure 127 and state save area (SSA) stack 302 according to embodiments of the disclosure. In one embodiment, (optionally) a shadow stack 306 is included to store a copy of the SSA stack 302. In some embodiments, the size of a frame in the State Save Area (SECS.SSAFRAMESIZE 304) defines the number of (e.g., 4KByte) pages in a single frame in the State Save Area. In some embodiments, the SSA frame size is large enough to hold the general-purpose register (GPR) state, the extended processor (XSAVE) state, and any miscellaneous state. In some embodiments, a secure enclave control structure (SECS) includes a base address of the enclave (SECS.BASEADDR), e.g., this defines the enclave's base linear address from which the offset to the base of the SSA stack is calculated. In some embodiments, number of state save area slots (TCS.NSSA) defines the total number of slots (frames) in the State Save Area stack. In some embodiments, the current state save area slot (TCS.CSSA) defines the slot to use on the next exit. In some embodiments, the State Save Area (TCS.OSSA) defines the offset of the base address of a set of State Save Area slots from the enclave's base address.

In some embodiments, when an AEX occurs (e.g., block 204 of method 200), hardware selects the SSA frame to use by examining TCS.CSSA, e.g., with the processor state saved into the SSA frame (e.g., and loaded with a synthetic state to avoid leaking secrets), certain pointers (e.g., a register stack pointer (RSP)) are restored to their values prior to enclave entry, and TCS.CSSA is incremented.

In some embodiments, an enclave entry happens only through specific enclave instructions (e.g., only EENTER or ERESUME) and/or an enclave exit happens only through specific enclave instructions or events (e.g., only EEXIT or an AEX).

In embodiments, a CHGCTX instruction may have format including a field to indicate the SSA to be used to provide state of the context to be entered (which may be called the destination context, e.g., the main context in method 200). The field, part or all of its content, and/or part or all of the content in a storage location indicated by the field's content may be referred to as an operand, argument, parameter, etc. of the CHGCTX instruction. For example, the field may be used to provide an address of or pointer to the SSA to provide state of the destination context, and/or, if context save areas are maintained within arrays, to provide an array index. In other embodiments, the SSA to be used to provide state of the destination context may be indicated according to another approach.

In embodiments, a CHGCTX instruction may have a format including an opcode field for an opcode, where the opcode may be decoded into one or more micro-instructions or micro-operations for execution, which may include one or more operations to perform a context change in response to the instruction. For example (as shown block 210 of in FIG. 2), the context change may be from a handler context to a main context and is performed within a TEE (i.e., without exiting the TEE).

A CHGCTX instruction format may also include one or more fields (such as the SSA field described above) for operands or to specify or indicate operands, arguments, or other parameters of or associated with the instruction. Operands, arguments, and/or other parameters may be associated with an instruction implicitly, directly, indirectly, or according to any other approach.

In some embodiments, a CHGCTX instruction may be a privileged or supervisor-level instruction. In some embodiments, a CHGCTX instruction may be an unprivileged or user-level instruction. In some embodiments, a CHGCTX instruction may be a leaf of another instruction (e.g., an SGX or SGX2 instruction). In some embodiments, a processor may perform a context change operation (e.g., as described herein as in response to a CHGCTX instruction), not or not only in response to an instruction having an opcode corresponding only to a context change operation, but in response to or in connection with one or more other events (e.g., a write to or setting of a specific bit or bits of a command, model-specific, machine-specific, or other register; changing an address/pointer to context state in registers/memory/storage such as through a write/store instruction/operation).

In various embodiments, the degree to which context is saved and/or restored by a CHGCTX instruction may vary, e.g., all processor context, some processor context, or no processor context may be saved and/or restored. In embodiments in which not all processor context is saved/restored by the operation of processor hardware (e.g., execution and/or load/store units), processor context may be saved/restored by software. For example, if the SSA is readable and/or writable by TEE software, then the TEE software may load the processor context from the SSA of the destination context, prior to invoking CHGCTX.

FIG. 2B illustrates aspects of embodiments in a method 220 for handling an exception (or other EEE) within an SGX secure enclave, using a CHGCTX instruction. In these embodiments, SSA frames (each corresponding to a single context) are stored within an array—one array per SGX enclave thread. Hence, as discussed above, CHGCTX may be implemented with an SSA index operand to indicate the destination SSA frame. However, to cover the expedited exception handling case described above, it suffices to simply have a CHGCTX implementation that decrements the current SSA (CSSA) index. Embodiments according to this approach may be referred to, for convenience, as DECCSSA, and a CHGCTX instruction according to this embodiment may be referred to as DECCSSA or a DECCSSA instruction. Commodity SGX software development kits (SDKs) and frameworks currently use a two-stage exception handling software flow that requires only two SSA frames: SSA[0] is used exclusively for the main context, SSA[1] is used exclusively by the exception handling flow. Therefore, DECCSSA may allow SGX enclave software to transition seamlessly from the exception handling context to the main context without having to exit and re-enter the enclave.

In method 220, block 222, enclave main flow begins in the main context, SSA[0]. In block 224, the enclave encounters an exception/interrupt, for example, at an instruction indicated by an instruction pointer (IP) in an IP register (RIP), e.g., RIP=0x1234. In block 226, the enclave exits asynchronously, which increments (e.g., automatically by operation of processor HW/FW/ucode) the CSSA index (e.g., to SSA[1]). In block 228, the enclave enters or re-enters (e.g., in response to an EENTER or ERESUME instruction) into the exception handling context, SSA[1], by operation of the software invoking the enter or resume instruction.

In block 230 (e.g., automatically by operation of HW/FW/ucode), the processor detects, at the enclave entry point, that the CSSA is greater than zero, and it jumps to an exception handler (in this example, a stage-1 handler in a two-stage exception handling scheme).

In block 232, the stage-1 handler ensures that the stage-2 handler will have enough stack, expanding the stack if necessary. In block 234, the stage-1 handler copies SSA[0] context, as necessary, into the stage-2 handler's stack, for example, GPRs, exit information, flags, etc. In embodiments, block 234 may include copying state from an extended state save (e.g., XSAVE) region, if any, from SSA[0] to the stack. In other embodiments, in which neither the exception handlers nor an attack mitigation flow (if any), touch extended states, the extended states (if any) may be loaded back with an extended state restore instruction (e.g., XRSTOR).

In block 236, the stage-1 handler invokes a DECCSSA instruction to switch the context to the main context, SSA[0]. In block 238, the stage-1 handler jumps to the stage-2 handler.

In block 240, the stage-2 handler handles the exception. In block 242, the stage-2 handler restores state, as necessary. In block 244, the stage-2 handler returns to the IP at which the exception occurred (e.g., RIP 0x1234).

In this embodiment, execution in response to a DECCSSA instruction (e.g., invoked in block 236) would only alter the context index (i.e., CSSA); enclave software would be responsible for restoring processor context (e.g., in block 234). In other embodiments, execution in response to a DECCSSA instruction may include one or more operations to automatically (e.g., by processor HW/FW/ucode) restore processor context.

FIG. 2C illustrates aspects of embodiments in a method 250 for handling an exception (or other EEE) within a TEE, using a CHGCTX instruction, to mitigate potential side channel attacks. In these embodiments, a new mode (to be referred to as MODE) is introduced, in which an enclave resume instruction (e.g., ERESUME) is transformed into an enclave enter instruction (e.g., EENTER). When MODE is enabled, asynchronous enclave exits caused by an exception or interrupt raise an enclave software handler in a new context whenever the enclave is re-entered. Therefore, mitigations against malicious side-channel attacks may be applied. In these embodiments, use of a DECCSSA instruction provides a mechanism to quickly return to the main context (e.g., SSA[0]), thus avoiding significant overhead each time the enclave is interrupted or encounters an exception.

In method 250, block 252, enclave main flow begins in the main context, SSA[0]. In block 254, enclave software enables MODE. In block 256, the enclave encounters an exception/interrupt, for example, at RIP=0x1234. In block 258, the enclave exits asynchronously, which increments (e.g., automatically by operation of processor HW/FW/ucode) the CSSA index (e.g., to SSA[1]).

In block 260, the enclave enters or re-enters (e.g., in response to an EENTER or ERESUME instruction), and, automatically by operation of processor HW/FW/ucode, MODE forces the enclave into the exception handling context, SSA[1].

In block 262 (e.g., automatically by operation of HW/FW/ucode), the processor detects, at the enclave entry point, that the CSSA is greater than zero, and it jumps to an exception handler to apply mitigations. In block 264, the exception handler restores state, as necessary, from SSA[0]. In block 266, the exception handler invokes a DECCSSA instruction to switch the context to the main context, SSA[0]. In block 268, the exception handler returns to the IP at which the exception occurred (e.g., RIP 0x1234).

In block 270, enclave execution continues in the main context, with mitigations applied. In block 272, the enclave software disables MODE. In block 274, the enclave exits.

In some embodiments, a two-stage exception handler flow (e.g., as shown in FIG. 2B) could also be augmented to apply mitigations if desired (e.g., by an enclave developer).

In some examples, AEX Notify allows SGX enclaves to be notified after an asynchronous enclave exit (AEX) has occurred. Specifically, an enclave software handler can be raised following an ERESUME. Potential use cases may include exception handling and applying side channel mitigations.

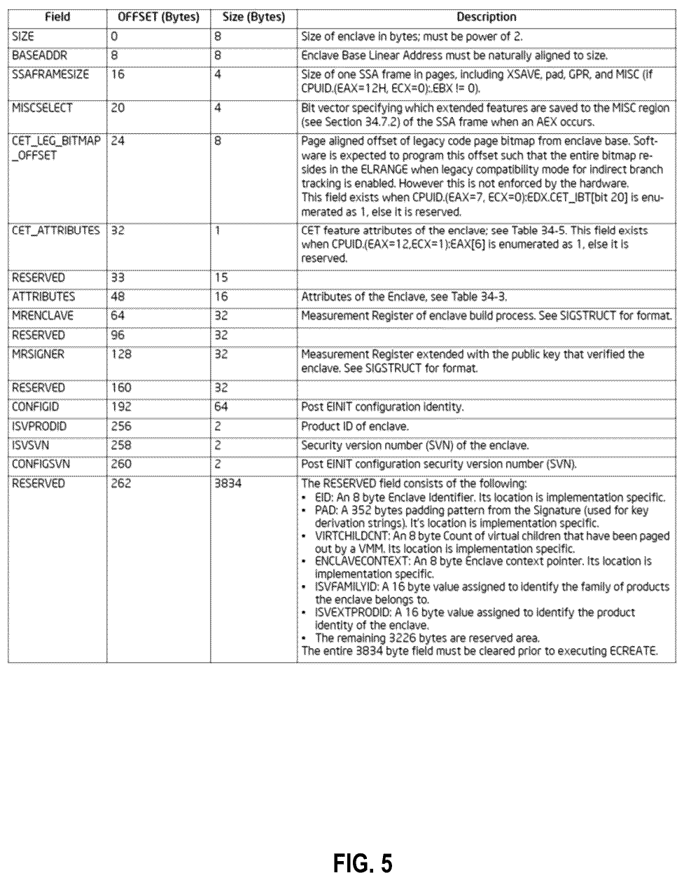

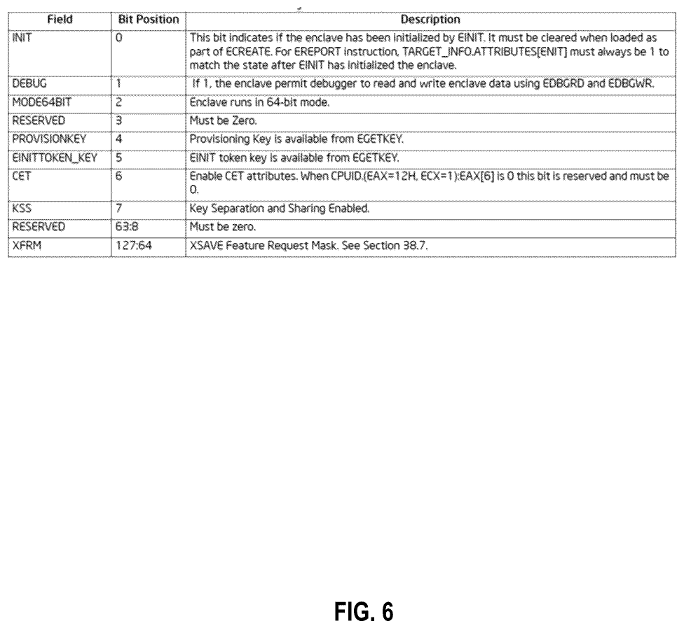

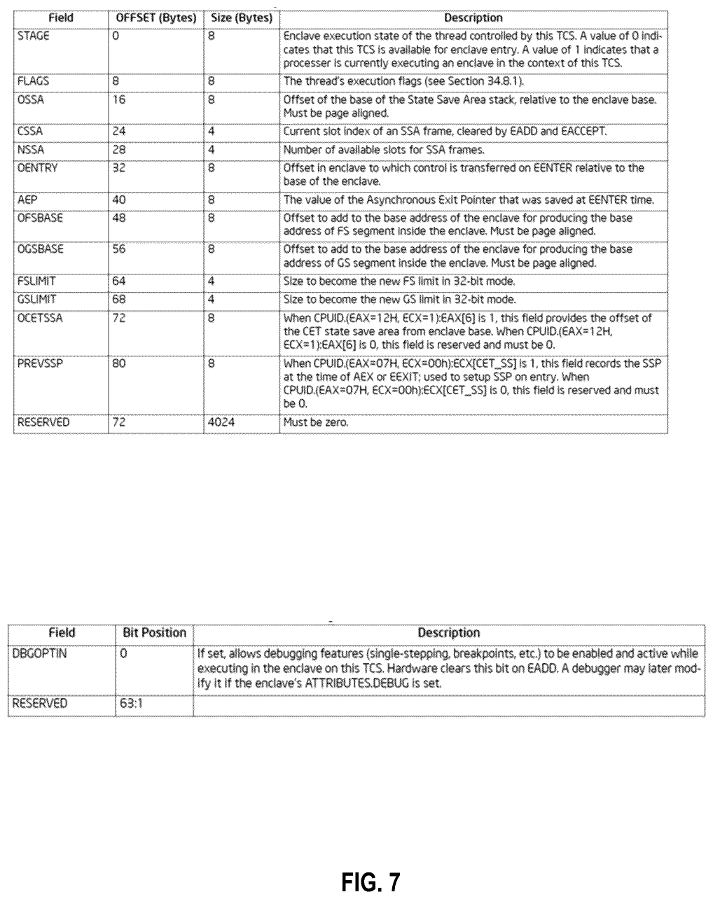

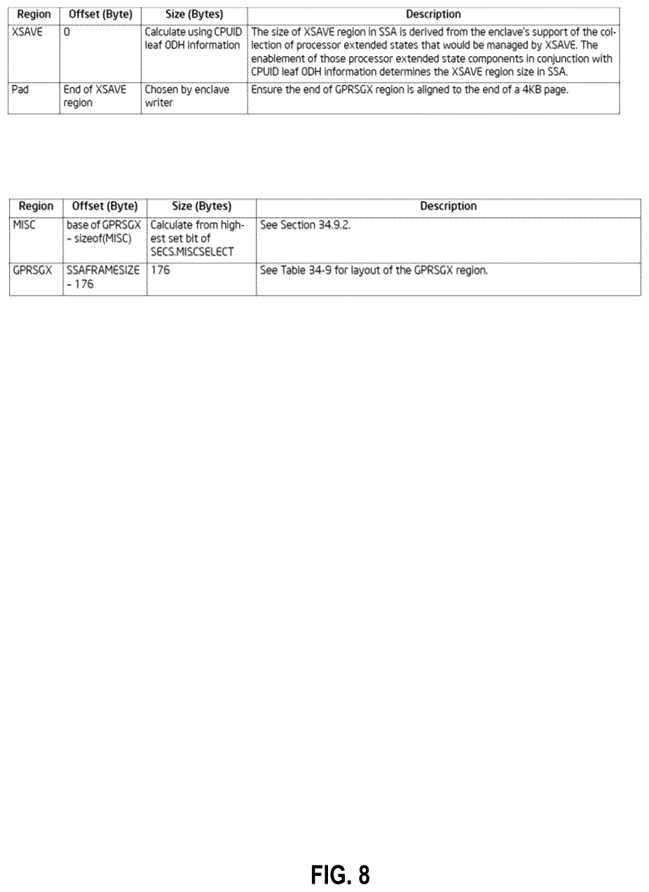

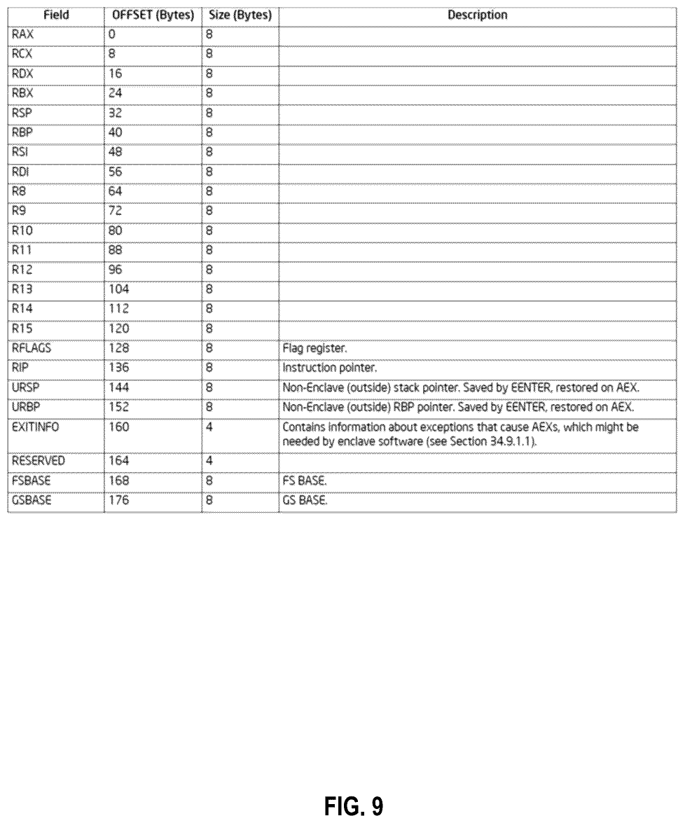

In some examples, the following proposed additions to existing SGX and TCS data structures support AEX Notify (non-modified examples are shown in FIG. 5 (showing examples of SECS), FIG. 6 (showing examples of the attributes field of SECS), FIG. 7 (showing examples of TCS and TCS.FLAGS), FIG. 8 (showing examples of a SSA frame), and FIG. 9 (showing examples of SSA.GPRSGX)): SECS.ATTRIBUTES.AEXNOTIFY: This enclave supports the AEX Notify feature TCS.FLAGS.AEXNOTIFY: This enclave thread may receive AEX notifications SSA.GPRSGX.AEXNOTIFY: Enclave-writable byte that enables AEX notifications

A TCS can only be entered via EENTER/ERESUME if SECS.ATTRIBUTES.AEXNOTIFY=TCS.FLAGS.AEXNOTIFY. A ERESUME flow that supports AEX Notify is summarized as follows:

IF (TCS.FLAGS.AEXNOTIFY = 1 &&
SSA[TCS.CSSA−1].GPRSGX.AEXNOTIFY = 1)
Then
<< Do EENTER flow >> Else
<< Do original ERESUME flow >>
FI;

In some examples, an AEX notification will be triggered by ERESUME if: the enclave thread allows AEX notifications (TCS.FLAGS.AEXNOTIFY is set), SSA[TCS.CSSA-1]. GPRSGX.AEXNOTIFY is set for the TCS that is being resumed, and TCS.CSSA (the current SSA pointer) is greater than zero.

In some examples, AEX increments TCS.CSSA, and ERESUME decrements TCS.CSSA—except when an AEX Notification is delivered. Instead of decrementing TCS.CSSA and restoring state from the SSA, ERESUME delivers an AEX notification by behaving as an EENTER. Several implications of this proposed behavior include:
The enclave thread is resumed at EnclaveBase+TCS.OENTRY
The enclave thread receives the (non-decremented) value of TCS.CSSA in EAX
RCX contains the address of the IP following ERESUME
The state saved by the most recent AEX is preserved in SSA[TCS.CSSA-1]

The enclave can return to the previous SSA context by invoking a proposed ENCLU leaf called EDECCSSA. An example pseudocode flow for EDECCSSA is:

If (TCS.CSSA == 0) #GP(0);
<< Validate TCS.SSA[TCS.CSSA−1] >>
TCS.CSSA <− TCS.CSSA − 1;

Before invoking EDECCSSA, enclave software should restore all required state from SSA[TCS.CSSA-1], for example, GPRs and XSAVE state. After invoking EDECCSSA, the enclave may jump to the RIP where the most recent AEX has occurred. Note that EDECCSSA does not modify flags in some examples.

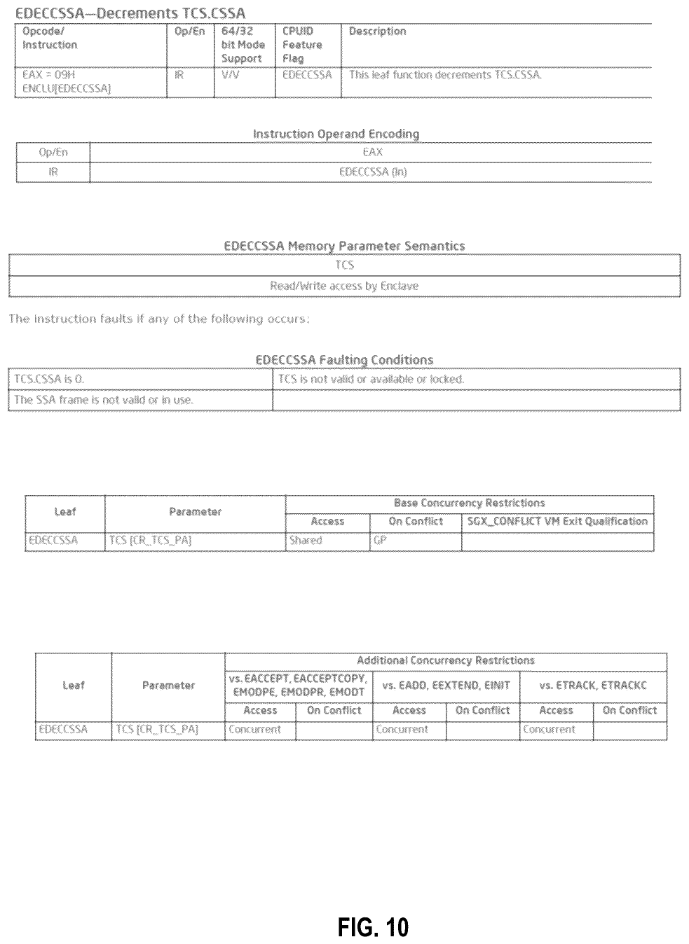

In some examples, EDECCSSA has a format, parameter semantics, faulting conditions, concurrency restrictions, etc. as shown in FIG. 10.

In some examples, the operation of EDECCSSA is as follows (where TMP_SSA is the address of a current SSA frame, TMP_XSIZE is a size of an XSAVE area, TMP_SSA_PAGE is a pointer used to iterate over the SSA pages in the target frame, TMP_GPR is an address of the GPR area within the target SSA frame, TMP_XSAVE_PAGE_PA_n is a physical address of the nth page within the target SSA frame, TMP_CET_SAVE_AREA is an address of the current CET save area, and TMP_CET_SAVE page is an address of the current CET save area page):

```
IF (CR_TCS_PA.CSSA = 0)
  THEN #GP(0); FI;
  (* Compute linear address of SSA frame *)
  TMP_SSA := CR_TCS_PA.OSSA + CR_ACTIVE_SECS.BASEADDR + 4096 * CR_ACTIVE_SECS.SSAFRAMESIZE *
  (CR_TCS_PA.CSSA − 1);
  TMP_XSIZE := compute_XSAVE_frame_size(CR_ACTIVE_SECS.ATTRIBUTES.XFRM);
  FOR EACH TMP_SSA_PAGE = TMP_SSA to TMP_SSA + TMP_XSIZE
  (* Check page is read/write accessible *)
  Check that DS:TMP_SSA_PAGE is read/write accessible;
  If a fault occurs, release locks, abort and deliver that fault;
  IF (DS:TMP_SSA_PAGE does not resolve to EPC page)
    THEN #PF(DS:TMP_SSA_PAGE);
    FI; IF
    (EPCM(DS:TMP_SSA_PAGE).VALID =
    0)
    THEN #PF(DS:TMP_SSA_PAGE); FI;
  IF (EPCM(DS:TMP_SSA_PAGE).BLOCKED = 1)
    THEN #PF(DS:TMP_SSA_PAGE); FI;
  IF ((EPCM(DS:TMP_SSA_PAGE).PENDING = 1) or (EPCM(DS:TMP_SSA_PAGE_.MODIFIED
    = 1)) THEN #PF(DS:TMP_SSA_PAGE); FI;
    IF (( EPCM(DS:TMP_SSA_PAGE).ENCLAVEADDRESS ≠ DS:TMPSSA_PAGE) or
    (EPCM(DS:TMP_SSA_PAGE).PT ≠ PT_REG) or
    (EPCM(DS:TMP_SSA_PAGE).ENCLAVESECS ≠
    EPCM(CR_TCS_PA).ENCLAVESECS) or (EPCM(DS:TMP_SSA_PAGE).R = 0)
    or (EPCM(DS:TMP_SSA_PAGE).W= 0) )
    THEN #PF(DS:TMP_SSA_PAGE); FI;
  TMP_XSAVE_PAGE_PA_n := Physical_Address(DS:TMP_SSA_PAGE);
      ENDFOR
    (* Compute address of GPR area*)
    TMP_GPR := TMP_SSA + 4096 * CR_ACTIVE_SECS.SSAFRAMESIZE − sizeof(GPRSGX_AREA);
    Check that DS:TMP_SSA_PAGE is read/write accessible;
    If a fault occurs, release locks, abort and deliver
    that fault; IF (DS:TMP_GPR does not resolve to
    EPC page)
    THEN #PF(DS:TMP_GPR); FI;
  IF (EPCM(DS:TMP_GPR).VALID = 0)
    THEN #PF(DS:TMP_GPR); FI;
  IF (EPCM(DS:TMP_GPR).BLOCKED =
    1) THEN #PF(DS:TMP_GPR); FI;
  IF ((EPCM(DS:TMP_GPR).PENDING = 1) or
    (EPCM(DS:TMP_GPR).MODIFIED = 1)) THEN #PF(DS:TMP_GPR);
    FI;
    IF (( EPCM(DS:TMP_GPR).ENCLAVEADDRESS ≠ DS:TMP_GPR) or
    (EPCM(DS:TMP_GPR).PT ≠ PT_REG) or
    (EPCM(DS:TMP_GPR).ENCLAVESECS ≠ EPCM(CR_TCS_PA).ENCLAVESECS)
    or (EPCM(DS:TMP_GPR).R = 0) or (EPCM(DS:TMP_GPR).W = 0) )
    THEN #PF(DS:TMP_GPR); FI;
    IF (TMP_MODE64 = 0)
    THEN
  IF (TMP_GPR + (sizeof(GPRSGX_AREA) −1) is not in DS segment)
    THEN #GP(0); FI;
    FI;
  IF (CPUID.(EAX=12H, ECX=1):EAX[6] = 1)
    THEN
  IF ((CR_ACTIVE_SECS.CET_ATTRIBUTES.SH_STK_EN == 1) OR (CR_ACTIVE_SECS.CET_ATTRIBUTES.ENDBR_EN ==
    1)) THEN
    (* Compute linear address of what will become new CET state save area and cache its PA *)
    TMP_CET_SAVE_AREA := CR_TCS_PA.OCETSSA + CR_ACTIVE_SECS.BASEADDR + (CR_TCS_PA.CSSA − 1) * 16;
    TMP_CET_SAVE_PAGE := TMP_CET_SAVE_AREA & ~0xFFF;
    Check the TMP_CET_SAVE_PAGE page is read/write accessible If fault occurs
    release locks, abort and deliver fault
          FI;
        ( DIFIED, BLOCKED and PT fields atomically *) IF ((DS:TMP_CET_SAVE_PAGE
        * Does NOT RESOLVE TO EPC PAGE) OR
        r (EPCM(DS:TMP_CET_SAVE_PAGE). VALID = 0) OR
        e (EPCM(DS:TMP_CET_SAVE_PAGE).PENDING = 1) OR
        a (EPCM(DS:TMP_CET_SAVE_PAGE).MODIFIED = 1) OR
        d (EPCM(DS:TMP_CET_SAVE_PAGE).BLOCKED = 1) OR
        t (EPCM(DS:TMP_CET_SAVE_PAGE).R = 0) OR
        h (EPCM(DS:TMP_CET_SAVE_PAGE).W = 0) OR
        e (EPCM(DS:TMP_CET_SAVE_PAGE).ENCLAVEADDRESS [symbol]    DS:TMP_CET_SAVE_PAGE) OR
        E (EPCM(DS:TMP_CET_SAVE_PAGE).PT [symbol]    PT_SS_REST) OR
        P (EPCM(DS:TMP_CET_SAVE_PAGE).ENCLAVESECS [symbol]    EPCM(CR_TCS_PA).ENCLAVESECS))
      FI; C THEN #PF(DS:TMP_CET_SAVE_PAGE); FI;
        M
        V
        A
        L
        I
        D
        ,
        P
        E
        N
        D
        I
        N
        G
        ,
        M
        O
    (* At this point, the instruction is guaranteed to complete *)
    CR_TCS_PA.CSSA := CR_TCS_PA.CSSA − 1;
    CR_GPR_PA :=
    Physical_Address(DS:TMP_GPR); FOR
    EACH TMP_XSAVE_PAGE_n
    CR_XSAVE_PAGE_n := TMP_XSAVE_PAGE_PA_n;
    ENDFOR
  IF (CPUID.(EAX=12H, ECX=1):EAX[6] = 1)
    THEN
    IF ((TMP_SECS.CET_ATTRIBUTES.SH_STK_EN == 1) OR
    (TMP_SECS.CET_ATTRIBUTES.ENDBR_EN == 1))
    THEN
    CR_CET_SAVE_AREA_PA := Physical_Address(DS:TMP_CET_SAVE_AREA);
    FI;
    FI;
    Flags Affected
    None
    Protected Mode Exceptions
    #GP(0) If executed outside an enclave.
    If CR_TCS_PA.CSSA = 0.
    #PF(error code) If a page fault occurs in accessing memory.
    If one or more pages of the target SSA frame are not readable/writable, or do not resolve to a valid PT_REG
    EPC page.
    If CET is enabled for the enclave and the target CET SSA frame is not readable/writable, or does not resolve
    to a valid PT_REG EPC page.
    64-Bit Mode Exceptions
    #GP(0) If executed outside an enclave.
    If CR_TCS_PA.CSSA = 0.
    #PF(error code) If a page fault occurs in accessing memory.
```

FIG. 4 illustrates how AEX Notify can allow enclaves to handle exceptions more efficiently, without requiring an additional EENTER and EEXIT according to some examples. When an exception triggers an AEX, enclave execution is suspended, and control is transferred to the OS. The OS may then choose to deliver an exception signal to the uRTS (untrusted runtime system), which in turn can decide whether to allow the enclave to handle the exception; if so, the uRTS will unwind the exception by issuing a sigreturn and then returning to the enclave. Immediately following ERESUME, the enclave is notified that an AEX had occurred, and it can respond by handling the exception. The enclave thread may then resume execution where the AEX had occurred.

In some examples, an enclave thread cannot receive AEX notifications unless its TCS.FLAGS.AEXNOTIFY bit is set, and SECS.ATTRIBUTES.AEXNOTIFY is also set. The conjunction of these two enabling bits is required to maintain compatibility with other platform features. It also has implications for enclave signing, attestation, and sealing, because TCS.FLAGS is typically included in the MRENCLAVE measurement.

The enclave owner may want to be able to deploy a single enclave binary signed with a single SIGSTRUCT on hardware platforms that do support AEX Notify, and on hardware platforms that do not support AEX Notify. As the TCS.FLAGS.AEXNOTIFY enabling bit affects MRENCLAVE, this deployment model requires some additional software support. For example, the enclave owner may take a single measurement of the enclave that includes two sets of TCSs: one set with the TCS.FLAGS.AEXNOTIFY bit set, the other set with the bit cleared. Each platform can then build and measure the enclave with both sets of TCSs. Platforms that support AEX Notify would enter the enclave through the first set; platforms that do not support AEX Notify would only be able to enter through the second set because ERESUME and EENTER will issue a #GP if a reserved bit is set in TCS.FLAGS. As soon as the enclave has been entered once through either the first set or the second set, enclave software may can prevent any subsequent entry through TCSs within the other set. For instance, on the first entry the enclave can set an internal global flag to 1 if an AEX-Notify-enabled TCS was used, and 0 otherwise. Subsequent enclave entries can be gated by this flag.

Both enabling bits are exposed by attestation: TCS.FLAGS.AEXNOTIFY is included in the REPORT.MRENCLAVE measurement, and the SECS.ATTRIBUTES.AEXNOTIFY bit is revealed in REPORT.ATTRIBUTES.

When an enclave intends to seal sensitive data persistently, it uses the EGETKEY instruction to retrieve an encryption key. This key is derived containing the components of the enclave's identity and a value provided by the enclave called KEYID. By providing different values of KEYID, the enclave is able to access multiple seal keys, for example to ensure that no key is overused. In the signing model described above, the enclave would include an indicator in KEYID to derive a different key, depending on whether AEX Notify is enabled or disabled.

In some examples, existing SGX structures are modified such as having AEXNOTIFY enablement being indicated in bit position 10 of SECS.ATTRIBUTES, AEXNOTIFY feature enablement for a thread being indicated by bit position 1 of TCS.FLAGS, and having bit 0 of GPRSGX.AEXNOTIFY being an indication of AEX Notify being enabled for a particular SSA context.

In some examples, a control flow technology (CET) is supported. The CET state saved in a CETSSA frame must be copied (for example, to the stack) in the early stage of the handler before EDECCSSA is issued. Like SSA frames, CETSSA frames are also organized as an array indexed by TCS.CSSA.

An indirect JMP must be used instead of RET to return from the AEX handler. This is because the shadow stack would not have a matching return address. The CETSSA frame contains the value of the shadow stack pointer (SSP) and the state of indirect branch tracking (IBT) saved during AEX. The SSP usually does not require explicit restoration as long as it is in sync with the call stack. The IBT state contains a SUPPRESS bit and a TRACKER bit. SUPPRESS is not typically used in enclaves. TRACKER can be restored by the final JMP instruction by using the no-track prefix (to set TRACKER=0) or not using it (to set TRACKER=1).
Given that all GPRs must be restored before the final JMP, the target address would have to reside on the stack below RSP, so the handler must not overwrite the stack while the previous run of itself was returning when interrupted. A typical handler could test if the interrupted RIP equals the address of the final JMP, and if so, reuse the processor context saved on the stack (instead of the one in SSA[TCS.CSSA-1]) and return to the main flow where the AEX had occurred.

In some examples, EENTER is as follows:

EENTER is a serializing instruction. The instruction faults if any of the following occurs:

| | |
|---|---|
| Address in RBX is not properly aligned. | Any TCS.FLAGS's must-be-zero bit is not zero. |
| TCS pointed to by RBX is not valid or | Current 32/64 mode does not match the enclave mode in |
| available or locked. | SECS.ATTRIBUTES.MODE64. |
| The SECS is in use. | Either of TCS-specified FS and GS segment is not a subsets of |
| | the current DS segment. |
| Any one of DS, ES, CS, SS is not zero. | If XSAVE available, CR4.OSXSAVE = 0, but SECS.ATTRIBUTES.XFRM |
| | t- 3. |
| CR4.OSFXSR t- 1. | If CR4.OSXSAVE = 1, SECS.ATTRIBUTES.XFRM is not a subset of |
| | XCR0. |
| If SECS.ATTRIBUTES.AEXNOTIFY ≠ | |
| TCS.FLAGS.AEXNOTIFY and | |
| TCS.FLAGS.DBGOPTIN = 0. | |

In some examples, ERESUME is as follows:

The instruction faults if any of the following occurs:

| | |
|---|---|
| Address in RBX is not properly aligned. | Any TCS.FLAGS's must-be-zero bit is not zero. |
| TCS pointed to by RBX is not valid or | Current 32/64 mode does not match the enclave mode in |
| available or locked. | SECS.ATTRIBUTES.MODE64. |
| The SECS is in use by another enclave. | Either of TCS-specified FS and GS segment is not a subset of the |
| | current DS segment. |
| Any one of DS, ES, CS, SS is not zero. | If XSAVE available, CR4.OSXSAVE = 0, but SECS.ATTRIBUTES.XFRM t- |
| | 3. |
| CR4.OSFXSR ≠ 1. | If CR4.OSXSAVE = 1, SECS.ATTRIBUTES.XFRM is not a subset of |
| | XCR0. |
| Offsets of the XSAVE area not 0. | The bit vector stored at offset 512 of the XSAVE area must be a |
| | subset of SECS.ATTRIBUTES.XFRM. |
| The SSA frame is not valid or in use. | If SECS.ATTRIBUTES.AEXNOTIFY ≠ TCS.FLAGS.AEXNOTIFY and |
| | TCS.FLAGS.DBGOPTIN = 0. |

### Operation

### Temp Variables in ERESUME Operational Flow

| Name | Type | Size | Description |
|---|---|---|---|
| TMP_FSBASE | Effective | 32/64 | Proposed base address for FS segment. |
| | Address | | |
| TMP_GSBASE | Effective | 32/64 | Proposed base address for FS segment. |
| | Address | | |
| TMP_FSLIMIT | Effective | 32/64 | Highest legal address in proposed FS segment. |
| | Address | | |
| TMP_GSLIMIT | Effective | 32/64 | Highest legal address in proposed GS segment. |
| | Address | | |
| TMP_TARGET | Effective | 32/64 | Address of first instruction inside enclave at which execution |
| | Address | | is to resume. |
| TMP_SECS | Effective | 32/64 | Physical address of SECS for this enclave. |
| | Address | | |
| TMP_SSA | Effective | 32/64 | Address of current SSA frame. |
| | Address | | |
| TMP_XSIZE | integer | 64 | Size of XSAVE area based on SECS.ATTRIBUTES.XFRM. |
| TMP_SSA_PAGE | Effective | 32/64 | Pointer used to iterate over the SSA pages in the current |
| | Address | | frame. |
| TMP_GPR | Effective | 32/64 | Address of the GPR area within the current SSA frame. |
| | Address | | |
| TMP_BRANCH_RECORD | LBR Record | | From/to addresses to be pushed onto the LBR stack. |
| TMP_NOTIFY | Boolean | 1 | When set to 1, deliver an AEX notification. |

An enclave owner, typically an independent software vendor (ISV), can enable certain functionality and security features by selecting attributes within the enclave's signing structure that contains information about an enclave (e.g., SIGSTRUCT). This allows ISVs to enable enclave features.

However, it may be difficult to support when a new feature is being added by a patch that supports patch rollback. For example, a malicious operating system (OS) could perform the following steps to disable a must-use feature for an enclave:
1. OS loads the must-use feature patch in trial mode (that is, without incrementing SVN)
2. OS builds an enclave that must use the feature and produces a valid attestation report
3. OS rolls back the patch
4. OS runs the enclave without the feature
There is no existing infrastructure to safely rollback a TEE feature that has been added by a patch, and that is enabled via an enclave attribute.

Detailed herein are examples of how to prevent TEE entry if a feature introduced by a microcode patch is rolled back. If a TEE exposes an existing architectural (and software-accessible) data structure with reserved-bits for which a particular value (typically zero) is enforced by the architecture, then a microcode patch may define a new feature-bit within the structure. Software that uses functionality introduced by the microcode patch will set the feature-bit. If the microcode patch is rolled back, then the architecture's understanding of the feature-bit will revert to a reserved-bit. The existing architectural enforcement mechanism will therefore refuse to enter and/or construct the TEE instance.

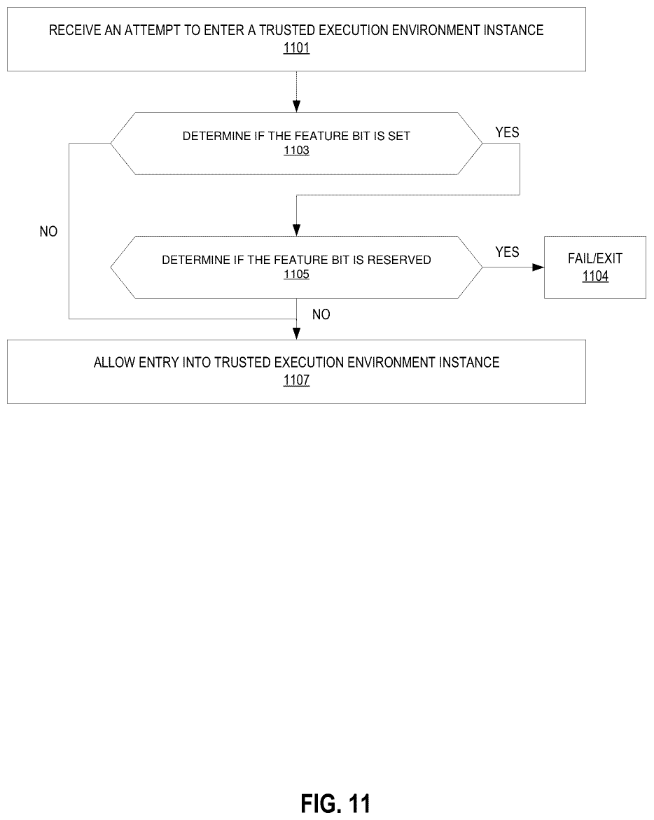

FIG. 11 illustrates examples of handling an attempt by software to enter a TEE. In some examples, microcode (e.g., microcode 190) or TEE logic 192 performs aspects of this flow. In some examples, software uses microcode (e.g., microcode 190) or TEE logic 192 to perform aspects of this flow. As shown, once the request to enter a TEE (e.g., a write, read, etc. of data in a TEE) has been received at 1101, a determination of if one or more features bit has/have been set is made at 1103. For example, the feature bit may be one that corresponds to some feature introduced by a microcode patch; if the patch is rolled back (or was never applied) then “the bit” is treated as a reserved bit. This bit may be in the TCS.FLAGS,

When the feature bit is set, a determination is made of if the feature bit is reserved at 1105. For example, the bit(s) corresponding to AEX notify may be set, but if that bit was supposed to be reserved (e.g., a rollback has occurred), then the entry will fail or exit 1104. If the bit was not reserved (e.g., no rollback has occurred), then the entry into the TEE is allowed at 1107. Similarly, when it is determined that a feature bit has not been set at 1103, then entry into the TEE is allowed at 1107.

TCS 127 is a software-constructed data structure that is used by TEE (e.g., SGX) to control the behavior of enclave threads. The TCS 127 exposes a bit-vector (referred to herein as called FLAGS) that consists of both defined and reserved bits. If any reserved bit in the TCS 127 is set, then execution of enclave entry instructions (e.g., EENTER) or resume instructions (e.g., ERESUME) will fail with a general protection fault (#GP). This behavior can be used to prevent an enclave from being executed after a microcode patch that introduces new TEE functionality has been rolled back. The following is an illustrative step-by-step example:
1. A microcode 190 or TEE logic 192 patch is loaded onto the platform. The microcode 190 or TEE logic 192 patch defines some bit (“new feature bit”) within the FLAGS bit vector that had been previously reserved. For example, bit position 10 in the bit vector is used to indicate the “new feature.”
2. The OS builds an enclave that uses the new functionality introduced by the microcode patch and the enclave owner enforces (e.g., via cryptographic measurement) that the bit is set for all enclave threads.
3. The OS executes the enclave by entering or resuming the enclave. For example, EENTER and ERESUME execute successfully because the bit has been defined by the microcode 190 or TEE logic 192 patch.
4. The OS rolls back the microcode 190 or TEE logic 192 patch causing the “new feature bit” to again be reserved as it was before step 1. For example, bit position 10 in the bit vector indicates reserved.
5. The OS attempts to execute the enclave. The entry into the enclave fails with a #GP fault because the “new feature bit” is set in the FLAGS bit vector, but the microcode 190 or TEE logic 192 sees this bit as being reserved. For example, because bit position 10 in the bit vector indicates reserved there should be no entry or resumption into the enclave.

As such, approach of reserve bit checking suffices to prevent a malicious OS from executing an enclave without the feature that was introduced by the microcode patch. Note that if the OS re-applies the patch after rolling it back, then the enclave may resume execution. This is not a security concern because the feature has been re-introduced by the patch.

TEE data structures (and fields within those data structures) are typically included in a cryptographic measurement that uniquely characterizes a particular TEE instance. This measurement may encompass reserved bits as is the case with TCS.FLAGS. This can be an inconvenience for any TEE/enclave owner who wants a single enclave binary—with a single measurement—to support platforms that may or may not expose a particular hardware feature. The trivial, yet inconvenient is to build two separate binaries: one that enables the feature, while the other does not.

In some examples, the TEE logic 192 or microcode 190 allows the structure that contains the reserved bit(s) to be replicated. For each instance of the data structure that sets the new feature bit (or more generally, for each instance of the new feature bit), an additional instance of the data structure will be constructed with the new feature bit cleared. For brevity, these two sets of structures are called feature-enabled structures (FESs) and feature-disabled structures (FDSs). Note that they are to be equal in number for a given TEE instance. Both the FESs and FDSs will be included in the cryptographic measurement of the TEE instance. On a platform that exposes the feature, the TEE instance will use the FESs; otherwise, it will use the FDSs.

In some examples, the mechanism by which the untrusted software will use either FES/FDS will vary by embodiment and must simply ensure that the FESs are being used if and only if the patch has not been rolled back. The TCS.FLAGS reserved bits are checked each time the enclave is entered by the TEE logic 192 or microcode 190. In some examples, the SECS.ATTRIBUTES or SSA.GPRSGX.AEXNOTIFY are checked. The first time that an enclave is entered, platform software may enter through an FES (i.e., a TCS whose new feature bit has been set) or an FDS (i.e., a TCS whose new feature bit has been cleared), depending on whether the platform supports the feature. If enclave software notices that it has been entered through an FES then it may take some action (e.g., set a flag) to prohibit subsequent entry through any of the FDSs. If the microcode patch that had introduced the feature is rolled back, then the architectural mechanism detailed in FIG. 11 suffices to prevent re-entry through an FES unless and until the patch is re-applied. Similarly, if the platform does not support the feature (or the platform owner does not want the enclave to use the feature) then platform software may enter the enclave through an FDS; the enclave will hence prohibit entry through any of the FESs.

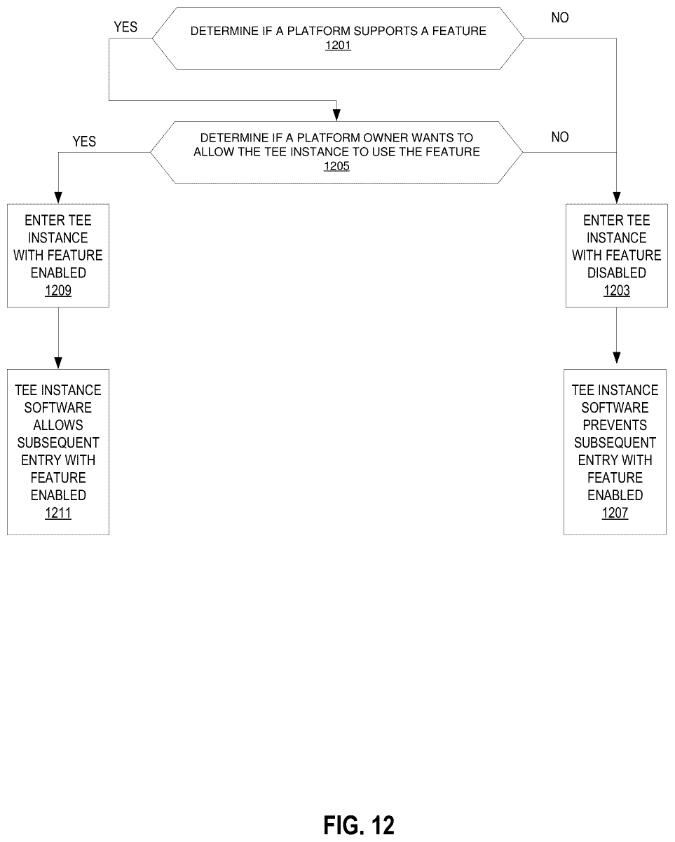

FIG. 12 illustrates examples of untrusted software (e.g., an OS or application) handling an attempt to enter a TEE. At 1201 a determination is made of if a platform supports a feature (e.g., by setting SECS.ATTRIBUTES. If the platform does not, then the TEE instance is entered with the feature disabled at 1203 and TEE instance software (e.g., using TEE logic 192 or microcode 190 ) prevents subsequent entry with the feature enabled at 1207.

If the platform does support the feature (e.g., no TCS.FLAGS setting or FDS indicates no support), then a determination is made of if a platform owner (e.g., software) wants to allow the TEE instance to use the feature at 1205. When the answer is no, then the TEE instance is entered with the feature disabled (e.g., by using an FDS) at 1203. To enter via FDS another check must be performed before TEE entry. TEE instance software (e.g., using TEE logic 192 or microcode 192) prevents subsequent entry with the feature enabled at 1207. When the answer is yes, then the TEE instance is entered with the feature enabled (e.g., by using an FES) at 1209 and TEE instance software using TEE logic 192 or microcode 190 allows subsequent entry with the feature enabled at 1211.

When an enclave intends to seal sensitive data persistently, it uses the EGETKEY instruction to retrieve an encryption key in some examples. This key may be derived containing the components of the enclave's identity and a value provided by the enclave called KEYID. By providing different values of KEYID, the enclave is able to access multiple seal keys, for example to ensure 1 key is not overused. In this IDF, the enclave would include an indicator in KEYID to indicate whether or not the feature is in use. This results in a different key when the feature is enabled or disabled.

Example architectures, etc. that support the above such as AEX Notify, TEE ERESUME instruction, rollback protection, etc. are detailed below.

### Example Computer Architectures

Detailed below are descriptions of example computer architectures. Other system designs and configurations known in the arts for laptop, desktop, and handheld personal computers (PC)s, personal digital assistants, engineering workstations, servers, disaggregated servers, network devices, network hubs, switches, routers, embedded processors, digital signal processors (DSPs), graphics devices, video game devices, set-top boxes, micro controllers, cell phones, portable media players, hand-held devices, and various other electronic devices, are also suitable. In general, a variety of systems or electronic devices capable of incorporating a processor and/or other execution logic as disclosed herein are generally suitable.

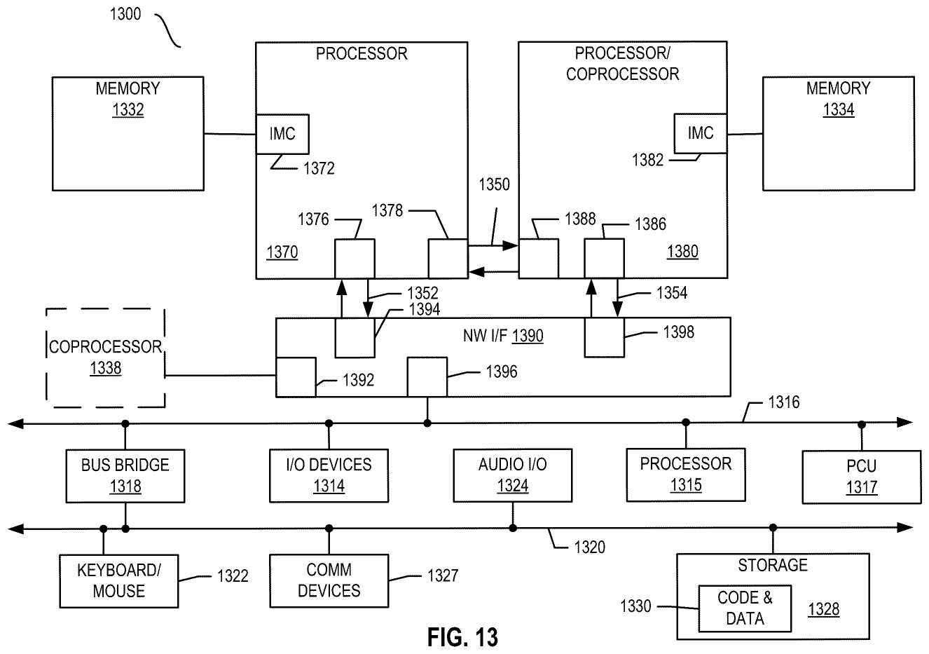

FIG. 13 illustrates an example computing system. Multiprocessor system 1300 is an interfaced system and includes a plurality of processors or cores including a first processor 1370 and a second processor 1380 coupled via an interface 1350 such as a point-to-point (P-P) interconnect, a fabric, and/or bus. In some examples, the first processor 1370 and the second processor 1380 are homogeneous. In some examples, first processor 1370 and the second processor 1380 are heterogenous. Though the example system 1300 is shown to have two processors, the system may have three or more processors, or may be a single processor system. In some examples, the computing system is a system on a chip (SoC).

Processors 1370 and 1380 are shown including integrated memory controller (IMC) circuitry 1372 and 1382, respectively. Processor 1370 also includes interface circuits 1376 and 1378; similarly, second processor 1380 includes interface circuits 1386 and 1388. Processors 1370, 1380 may exchange information via the interface 1350 using interface circuits 1378, 1388. IMCs 1372 and 1382 couple the processors 1370, 1380 to respective memories, namely a memory 1332 and a memory 1334, which may be portions of main memory locally attached to the respective processors.

Processors 1370, 1380 may each exchange information with a network interface (NW I/F) 1390 via individual interfaces 1352, 1354 using interface circuits 1376, 1394, 1386, 1398. The network interface 1390 (e.g., one or more of an interconnect, bus, and/or fabric, and in some examples is a chipset) may optionally exchange information with a coprocessor 1338 via an interface circuit 1392. In some examples, the coprocessor 1338 is a special-purpose processor, such as, for example, a high-throughput processor, a network or communication processor, compression engine, graphics processor, general purpose graphics processing unit (GPGPU), neural-network processing unit (NPU), embedded processor, or the like.

A shared cache (not shown) may be included in either processor 1370, 1380 or outside of both processors, yet connected with the processors via an interface such as P-P interconnect, such that either or both processors' local cache information may be stored in the shared cache if a processor is placed into a low power mode.

Network interface 1390 may be coupled to a first interface 1316 via interface circuit 1396. In some examples, first interface 1316 may be an interface such as a Peripheral Component Interconnect (PCI) interconnect, a PCI Express interconnect or another I/O interconnect. In some examples, first interface 1316 is coupled to a power control unit (PCU) 1317, which may include circuitry, software, and/or firmware to perform power management operations with regard to the processors 1370, 1380 and/or co-processor 1338. PCU 1317 provides control information to a voltage regulator (not shown) to cause the voltage regulator to generate the appropriate regulated voltage. PCU 1317 also provides control information to control the operating voltage generated. In various examples, PCU 1317 may include a variety of power management logic units (circuitry) to perform hardware-based power management. Such power management may be wholly processor controlled (e.g., by various processor hardware, and which may be triggered by workload and/or power, thermal or other processor constraints) and/or the power management may be performed responsive to external sources (such as a platform or power management source or system software).

PCU 1317 is illustrated as being present as logic separate from the processor 1370 and/or processor 1380. In other cases, PCU 1317 may execute on a given one or more of cores (not shown) of processor 1370 or 1380. In some cases, PCU 1317 may be implemented as a microcontroller (dedicated or general-purpose) or other control logic configured to execute its own dedicated power management code, sometimes referred to as P-code. In yet other examples, power management operations to be performed by PCU 1317 may be implemented externally to a processor, such as by way of a separate power management integrated circuit (PMIC) or another component external to the processor. In yet other examples, power management operations to be performed by PCU 1317 may be implemented within BIOS or other system software.

Various I/O devices 1314 may be coupled to first interface 1316, along with a bus bridge 1318 which couples first interface 1316 to a second interface 1320. In some examples, one or more additional processor(s) 1315, such as coprocessors, high throughput many integrated core (MIC) processors, GPGPUs, accelerators (such as graphics accelerators or digital signal processing (DSP) units), field programmable gate arrays (FPGAs), or any other processor, are coupled to first interface 1316. In some examples, second interface 1320 may be a low pin count (LPC) interface. Various devices may be coupled to second interface 1320 including, for example, a keyboard and/or mouse 1322, communication devices 1327 and storage circuitry 1328. Storage circuitry 1328 may be one or more non-transitory machine-readable storage media as described below, such as a disk drive or other mass storage device which may include instructions/code and data 1330 and may implement the storage 1303 in some examples. Further, an audio I/O 1324 may be coupled to second interface 1320. Note that other architectures than the point-to-point architecture described above are possible. For example, instead of the point-to-point architecture, a system such as multiprocessor system 1300 may implement a multi-drop interface or other such architecture.

### Example Core Architectures, Processors, and Computer Architectures

Processor cores may be implemented in different ways, for different purposes, and in different processors. For instance, implementations of such cores may include: 1) a general purpose in-order core intended for general-purpose computing; 2) a high-performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput) computing. Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip (SoC) that may be included on the same die as the described CPU (sometimes referred to as the application core(s) or application processor(s)), the above described coprocessor, and additional functionality. Example core architectures are described next, followed by descriptions of example processors and computer architectures.

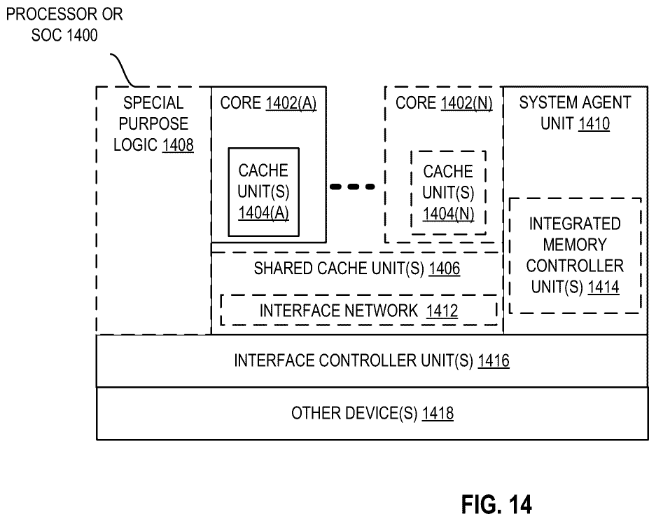

FIG. 14 illustrates a block diagram of an example processor and/or SoC 1400 that may have one or more cores and an integrated memory controller. The solid lined boxes illustrate a processor 1400 with a single core 1402(A), system agent unit circuitry 1410, and a set of one or more interface controller unit(s) circuitry 1416, while the optional addition of the dashed lined boxes illustrates an alternative processor 1400 with multiple cores 1402(A)-(N), a set of one or more integrated memory controller unit(s) circuitry 1414 in the system agent unit circuitry 1410, and special purpose logic 1408, as well as a set of one or more interface controller units circuitry 1416. Note that the processor 1400 may be one of the processors 1370 or 1380, or co-processor 1338 or 1315 of FIG. 13.

Thus, different implementations of the processor 1400 may include: 1) a CPU with the special purpose logic 1408 being integrated graphics and/or scientific (throughput) logic (which may include one or more cores, not shown), and the cores 1402(A)-(N) being one or more general purpose cores (e.g., general purpose in-order cores, general purpose out-of-order cores, or a combination of the two); 2) a coprocessor with the cores 1402(A)-(N) being a large number of special purpose cores intended primarily for graphics and/or scientific (throughput); and 3) a coprocessor with the cores 1402(A)-(N) being a large number of general purpose in-order cores. Thus, the processor 1400 may be a general-purpose processor, coprocessor or special-purpose processor, such as, for example, a network or communication processor, compression engine, graphics processor, GPGPU (general purpose graphics processing unit), a high throughput many integrated core (MIC) coprocessor (including 30 or more cores), embedded processor, or the like. The processor may be implemented on one or more chips. The processor 1400 may be a part of and/or may be implemented on one or more substrates using any of a number of process technologies, such as, for example, complementary metal oxide semiconductor (CMOS), bipolar CMOS (BiCMOS), P-type metal oxide semiconductor (PMOS), or N-type metal oxide semiconductor (NMOS).

A memory hierarchy includes one or more levels of cache unit(s) circuitry 1404(A)-(N) within the cores 1402(A)-(N), a set of one or more shared cache unit(s) circuitry 1406, and external memory (not shown) coupled to the set of integrated memory controller unit(s) circuitry 1414. The set of one or more shared cache unit(s) circuitry 1406 may include one or more mid-level caches, such as level 2 (L2), level 3 (L3), level 4 (L4), or other levels of cache, such as a last level cache (LLC), and/or combinations thereof. While in some examples interface network circuitry 1412 (e.g., a ring interconnect) interfaces the special purpose logic 1408 (e.g., integrated graphics logic), the set of shared cache unit(s) circuitry 1406, and the system agent unit circuitry 1410, alternative examples use any number of well-known techniques for interfacing such units. In some examples, coherency is maintained between one or more of the shared cache unit(s) circuitry 1406 and cores 1402(A)-(N). In some examples, interface controller units circuitry 1416 couple the cores 1402 to one or more other devices 1418 such as one or more I/O devices, storage, one or more communication devices (e.g., wireless networking, wired networking, etc.), etc.

In some examples, one or more of the cores 1402(A)-(N) are capable of multi-threading. The system agent unit circuitry 1410 includes those components coordinating and operating cores 1402(A)-(N). The system agent unit circuitry 1410 may include, for example, power control unit (PCU) circuitry and/or display unit circuitry (not shown). The PCU may be or may include logic and components needed for regulating the power state of the cores 1402(A)-(N) and/or the special purpose logic 1408 (e.g., integrated graphics logic). The display unit circuitry is for driving one or more externally connected displays.

The cores 1402(A)-(N) may be homogenous in terms of instruction set architecture (ISA). Alternatively, the cores 1402(A)-(N) may be heterogeneous in terms of ISA; that is, a subset of the cores 1402(A)-(N) may be capable of executing an ISA, while other cores may be capable of executing only a subset of that ISA or another ISA.

### Example Core Architectures—In-Order and Out-of-Order Core Block Diagram

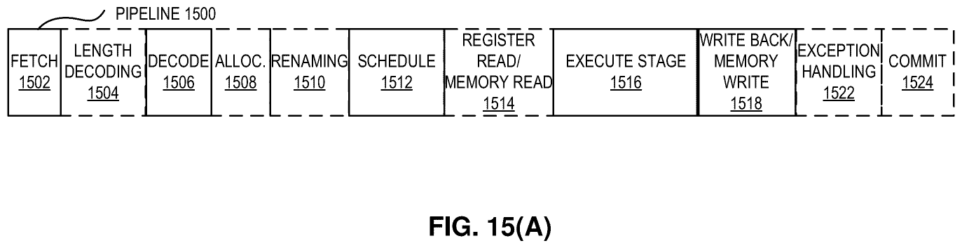

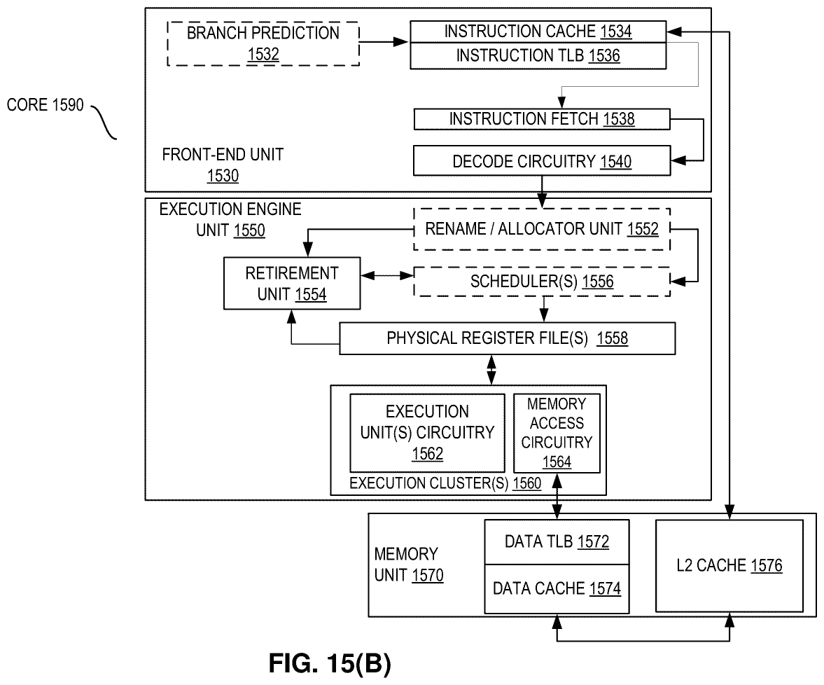

FIG. 15(A) is a block diagram illustrating both an example in-order pipeline and an example register renaming, out-of-order issue/execution pipeline according to examples. FIG. 15(B) is a block diagram illustrating both an example in-order architecture core and an example register renaming, out-of-order issue/execution architecture core to be included in a processor according to examples. The solid lined boxes in FIGS. 15(A)-(B) illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 15(A), a processor pipeline 1500 includes a fetch stage 1502, an optional length decoding stage 1504, a decode stage 1506, an optional allocation (Alloc) stage 1508, an optional renaming stage 1510, a schedule (also known as a dispatch or issue) stage 1512, an optional register read/memory read stage 1514, an execute stage 1516, a write back/memory write stage 1518, an optional exception handling stage 1522, and an optional commit stage 1524. One or more operations can be performed in each of these processor pipeline stages. For example, during the fetch stage 1502, one or more instructions are fetched from instruction memory, and during the decode stage 1506, the one or more fetched instructions may be decoded, addresses (e.g., load store unit (LSU) addresses) using forwarded register ports may be generated, and branch forwarding (e.g., immediate offset or a link register (LR)) may be performed. In one example, the decode stage 1506 and the register read/memory read stage 1514 may be combined into one pipeline stage. In one example, during the execute stage 1516, the decoded instructions may be executed, LSU address/data pipelining to an Advanced Microcontroller Bus (AMB) interface may be performed, multiply and add operations may be performed, arithmetic operations with branch results may be performed, etc.

By way of example, the example register renaming, out-of-order issue/execution architecture core of FIG. 15(B) may implement the pipeline 1500 as follows: 1) the instruction fetch circuitry 1538 performs the fetch and length decoding stages 1502 and 1504; 2) the decode circuitry 1540 performs the decode stage 1506; 3) the rename/allocator unit circuitry 1552 performs the allocation stage 1508 and renaming stage 1510; 4) the scheduler(s) circuitry 1556 performs the schedule stage 1512; 5) the physical register file(s) circuitry 1558 and the memory unit circuitry 1570 perform the register read/memory read stage 1514; the execution cluster(s) 1560 perform the execute stage 1516; 6) the memory unit circuitry 1570 and the physical register file(s) circuitry 1558 perform the write back/memory write stage 1518; 7) various circuitry may be involved in the exception handling stage 1522; and 8) the retirement unit circuitry 1554 and the physical register file(s) circuitry 1558 perform the commit stage 1524.

FIG. 15(B) shows a processor core 1590 including front-end unit circuitry 1530 coupled to execution engine unit circuitry 1550, and both are coupled to memory unit circuitry 1570. The core 1590 may be a reduced instruction set architecture computing (RISC) core, a complex instruction set architecture computing (CISC) core, a very long instruction word (VLIW) core, or a hybrid or alternative core type. As yet another option, the core 1590 may be a special-purpose core, such as, for example, a network or communication core, compression engine, coprocessor core, general purpose computing graphics processing unit (GPGPU) core, graphics core, or the like.

The front-end unit circuitry 1530 may include branch prediction circuitry 1532 coupled to instruction cache circuitry 1534, which is coupled to an instruction translation lookaside buffer (TLB) 1536, which is coupled to instruction fetch circuitry 1538, which is coupled to decode circuitry 1540. In one example, the instruction cache circuitry 1534 is included in the memory unit circuitry 1570 rather than the front-end circuitry 1530. The decode circuitry 1540 (or decoder) may decode instructions, and generate as an output one or more micro-operations, micro-code entry points, microinstructions, other instructions, or other control signals, which are decoded from, or which otherwise reflect, or are derived from, the original instructions. The decode circuitry 1540 may further include address generation unit (AGU, not shown) circuitry. In one example, the AGU generates an LSU address using forwarded register ports, and may further perform branch forwarding (e.g., immediate offset branch forwarding, LR register branch forwarding, etc.). The decode circuitry 1540 may be implemented using various different mechanisms. Examples of suitable mechanisms include, but are not limited to, look-up tables, hardware implementations, programmable logic arrays (PLAs), microcode read only memories (ROMs), etc. In one example, the core 1590 includes a microcode ROM (not shown) or other medium that stores microcode for certain macroinstructions (e.g., in decode circuitry 1540 or otherwise within the front-end circuitry 1530). In one example, the decode circuitry 1540 includes a micro-operation (micro-op) or operation cache (not shown) to hold/cache decoded operations, micro-tags, or micro-operations generated during the decode or other stages of the processor pipeline 1500. The decode circuitry 1540 may be coupled to rename/allocator unit circuitry 1552 in the execution engine circuitry 1550.

The execution engine circuitry 1550 includes the rename/allocator unit circuitry 1552 coupled to retirement unit circuitry 1554 and a set of one or more scheduler(s) circuitry 1556. The scheduler(s) circuitry 1556 represents any number of different schedulers, including reservations stations, central instruction window, etc. In some examples, the scheduler(s) circuitry 1556 can include arithmetic logic unit (ALU) scheduler/scheduling circuitry, ALU queues, address generation unit (AGU) scheduler/scheduling circuitry, AGU queues, etc. The scheduler(s) circuitry 1556 is coupled to the physical register file(s) circuitry 1558. Each of the physical register file(s) circuitry 1558 represents one or more physical register files, different ones of which store one or more different data types, such as scalar integer, scalar floating-point, packed integer, packed floating-point, vector integer, vector floating-point, status (e.g., an instruction pointer that is the address of the next instruction to be executed), etc. In one example, the physical register file(s) circuitry 1558 includes vector registers unit circuitry, writemask registers unit circuitry, and scalar register unit circuitry. These register units may provide architectural vector registers, vector mask registers, general-purpose registers, etc. The physical register file(s) circuitry 1558 is coupled to the retirement unit circuitry 1554 (also known as a retire queue or a retirement queue) to illustrate various ways in which register renaming and out-of-order execution may be implemented (e.g., using a reorder buffer(s) (ROB(s)) and a retirement register file(s); using a future file(s), a history buffer(s), and a retirement register file(s); using a register maps and a pool of registers; etc.). The retirement unit circuitry 1554 and the physical register file(s) circuitry 1558 are coupled to the execution cluster(s) 1560. The execution cluster(s) 1560 includes a set of one or more execution unit(s) circuitry 1562 and a set of one or more memory access circuitry 1564. The execution unit(s) circuitry 1562 may perform various arithmetic, logic, floating-point or other types of operations (e.g., shifts, addition, subtraction, multiplication) and on various types of data (e.g., scalar integer, scalar floating-point, packed integer, packed floating-point, vector integer, vector floating-point). While some examples may include a number of execution units or execution unit circuitry dedicated to specific functions or sets of functions, other examples may include only one execution unit circuitry or multiple execution units/execution unit circuitry that all perform all functions. The scheduler(s) circuitry 1556, physical register file(s) circuitry 1558, and execution cluster(s) 1560 are shown as being possibly plural because certain examples create separate pipelines for certain types of data/operations (e.g., a scalar integer pipeline, a scalar floating-point/packed integer/packed floating-point/vector integer/vector floating-point pipeline, and/or a memory access pipeline that each have their own scheduler circuitry, physical register file(s) circuitry, and/or execution cluster—and in the case of a separate memory access pipeline, certain examples are implemented in which only the execution cluster of this pipeline has the memory access unit(s) circuitry 1564). It should also be understood that where separate pipelines are used, one or more of these pipelines may be out-of-order issue/execution and the rest in-order.

In some examples, the execution engine unit circuitry 1550 may perform load store unit (LSU) address/data pipelining to an Advanced Microcontroller Bus (AMB) interface (not shown), and address phase and writeback, data phase load, store, and branches.

The set of memory access circuitry 1564 is coupled to the memory unit circuitry 1570, which includes data TLB circuitry 1572 coupled to data cache circuitry 1574 coupled to level 2 (L2) cache circuitry 1576. In one example, the memory access circuitry 1564 may include load unit circuitry, store address unit circuitry, and store data unit circuitry, each of which is coupled to the data TLB circuitry 1572 in the memory unit circuitry 1570. The instruction cache circuitry 1534 is further coupled to the level 2 (L2) cache circuitry 1576 in the memory unit circuitry 1570. In one example, the instruction cache 1534 and the data cache 1574 are combined into a single instruction and data cache (not shown) in L2 cache circuitry 1576, level 3 (L3) cache circuitry (not shown), and/or main memory. The L2 cache circuitry 1576 is coupled to one or more other levels of cache and eventually to a main memory.

The core 1590 may support one or more instructions sets (e.g., the x86 instruction set architecture (optionally with some extensions that have been added with newer versions); the MIPS instruction set architecture; the ARM instruction set architecture (optionally with optional additional extensions such as NEON)), including the instruction(s) described herein. In one example, the core 1590 includes logic to support a packed data instruction set architecture extension (e.g., AVX1, AVX2), thereby allowing the operations used by many multimedia applications to be performed using packed data.

### Example Execution Unit(s) Circuitry

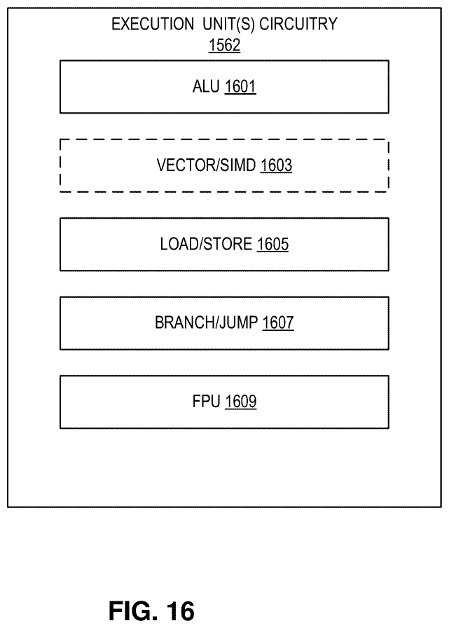

FIG. 16 illustrates examples of execution unit(s) circuitry, such as execution unit(s) circuitry 1562 of FIG. 15(B). As illustrated, execution unit(s) circuity 1562 may include one or more ALU circuits 1601, optional vector/single instruction multiple data (SIMD) circuits 1603, load/store circuits 1605, branch/jump circuits 1607, and/or Floating-point unit (FPU) circuits 1609. ALU circuits 1601 perform integer arithmetic and/or Boolean operations. Vector/SIMD circuits 1603 perform vector/SIMD operations on packed data (such as SIMD/vector registers). Load/store circuits 1605 execute load and store instructions to load data from memory into registers or store from registers to memory. Load/store circuits 1605 may also generate addresses. Branch/jump circuits 1607 cause a branch or jump to a memory address depending on the instruction. FPU circuits 1609 perform floating-point arithmetic. The width of the execution unit(s) circuitry 1562 varies depending upon the example and can range from 16-bit to 1,024-bit, for example. In some examples, two or more smaller execution units are logically combined to form a larger execution unit (e.g., two 128-bit execution units are logically combined to form a 256-bit execution unit).

### Example Register Architecture

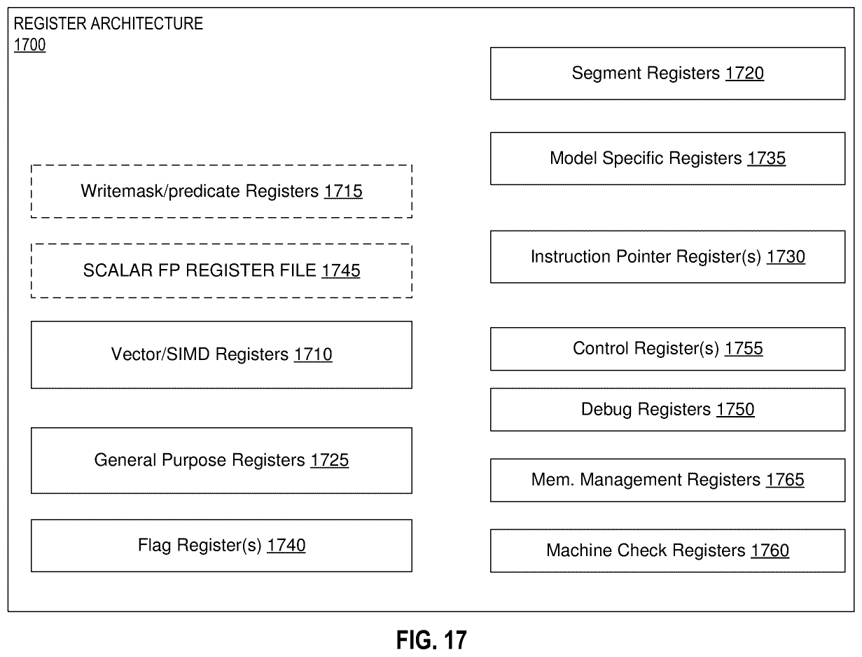

FIG. 17 is a block diagram of a register architecture 1700 according to some examples. As illustrated, the register architecture 1700 includes vector/SIMD registers 1710 that vary from 128-bit to 1,024 bits width. In some examples, the vector/SIMD registers 1710 are physically 512-bits and, depending upon the mapping, only some of the lower bits are used. For example, in some examples, the vector/SIMD registers 1710 are ZMM registers which are 512 bits: the lower 256 bits are used for YMM registers and the lower 128 bits are used for XMM registers. As such, there is an overlay of registers. In some examples, a vector length field selects between a maximum length and one or more other shorter lengths, where each such shorter length is half the length of the preceding length. Scalar operations are operations performed on the lowest order data element position in a ZMM/YMM/XMM register; the higher order data element positions are either left the same as they were prior to the instruction or zeroed depending on the example.

In some examples, the register architecture 1700 includes writemask/predicate registers 1715. For example, in some examples, there are 8 writemask/predicate registers (sometimes called k0 through k7) that are each 16-bit, 32-bit, 64-bit, or 128-bit in size. Writemask/predicate registers 1715 may allow for merging (e.g., allowing any set of elements in the destination to be protected from updates during the execution of any operation) and/or zeroing (e.g., zeroing vector masks allow any set of elements in the destination to be zeroed during the execution of any operation). In some examples, each data element position in a given writemask/predicate register 1715 corresponds to a data element position of the destination. In other examples, the writemask/predicate registers 1715 are scalable and consists of a set number of enable bits for a given vector element (e.g., 8 enable bits per 64-bit vector element).

The register architecture 1700 includes a plurality of general-purpose registers 1725. These registers may be 16-bit, 32-bit, 64-bit, etc. and can be used for scalar operations. In some examples, these registers are referenced by the names RAX, RBX, RCX, RDX, RBP, RSI, RDI, RSP, and R8 through R15.

In some examples, the register architecture 1700 includes scalar floating-point (FP) register file 1745 which is used for scalar floating-point operations on 32/64/80-bit floating-point data using the x87 instruction set architecture extension or as MMX registers to perform operations on 64-bit packed integer data, as well as to hold operands for some operations performed between the MMX and XMM registers.

One or more flag registers 1740 (e.g., EFLAGS, RFLAGS, etc.) store status and control information for arithmetic, compare, and system operations. For example, the one or more flag registers 1740 may store condition code information such as carry, parity, auxiliary carry, zero, sign, and overflow. In some examples, the one or more flag registers 1740 are called program status and control registers.

Segment registers 1720 contain segment points for use in accessing memory. In some examples, these registers are referenced by the names CS, DS, SS, ES, FS, and GS.

Model specific registers or machine specific registers (MSRs) 1735 control and report on processor performance. Most MSRs 1735 handle system-related functions and are not accessible to an application program. For example, MSRs may provide control for one or more of: performance-monitoring counters, debug extensions, memory type range registers, thermal and power management, instruction-specific support, and/or processor feature/mode support. Machine check registers 1760 consist of control, status, and error reporting MSRs that are used to detect and report on hardware errors. Control register(s) 1755 (e.g., CR0-CR4) determine the operating mode of a processor (e.g., processor 1370, 1380, 1338, 1315, and/or 1400) and the characteristics of a currently executing task. In some examples, MSRs 1735 are a subset of control registers 1755.

One or more instruction pointer register(s) 1730 store an instruction pointer value. Debug registers 1750 control and allow for the monitoring of a processor or core's debugging operations.

Memory (mem) management registers 1765 specify the locations of data structures used in protected mode memory management. These registers may include a global descriptor table register (GDTR), interrupt descriptor table register (IDTR), task register, and a local descriptor table register (LDTR) register.

Alternative examples may use wider or narrower registers. Additionally, alternative examples may use more, less, or different register files and registers. The register architecture 1700 may, for example, be used in register file/memory 1308, or physical register file(s) circuitry 15 58.

### Instruction Set Architectures

An instruction set architecture (ISA) may include one or more instruction formats. A given instruction format may define various fields (e.g., number of bits, location of bits) to specify, among other things, the operation to be performed (e.g., opcode) and the operand(s) on which that operation is to be performed and/or other data field(s) (e.g., mask). Some instruction formats are further broken down through the definition of instruction templates (or sub-formats). For example, the instruction templates of a given instruction format may be defined to have different subsets of the instruction format's fields (the included fields are typically in the same order, but at least some have different bit positions because there are less fields included) and/or defined to have a given field interpreted differently. Thus, each instruction of an ISA is expressed using a given instruction format (and, if defined, in a given one of the instruction templates of that instruction format) and includes fields for specifying the operation and the operands. For example, an example ADD instruction has a specific opcode and an instruction format that includes an opcode field to specify that opcode and operand fields to select operands (source1/destination and source 2); and an occurrence of this ADD instruction in an instruction stream will have specific contents in the operand fields that select specific operands. In addition, though the description below is made in the context of x86 ISA, it is within the knowledge of one skilled in the art to apply the teachings of the present disclosure in another ISA.

### Example Instruction Formats

Examples of the instruction(s) described herein may be embodied in different formats. Additionally, example systems, architectures, and pipelines are detailed below. Examples of the instruction(s) may be executed on such systems, architectures, and pipelines, but are not limited to those detailed.

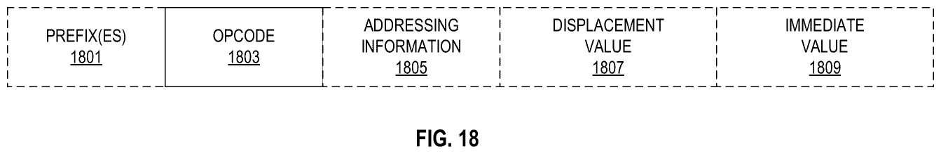

FIG. 18 illustrates examples of an instruction format. As illustrated, an instruction may include multiple components including, but not limited to, one or more fields for: one or more prefixes 1801, an opcode 1803, addressing information 1805 (e.g., register identifiers, memory addressing information, etc.), a displacement value 1807, and/or an immediate value 1809. Note that some instructions utilize some or all the fields of the format whereas others may only use the field for the opcode 1803. In some examples, the order illustrated is the order in which these fields are to be encoded, however, it should be appreciated that in other examples these fields may be encoded in a different order, combined, etc.

The prefix(es) field(s) 1801, when used, modifies an instruction. In some examples, one or more prefixes are used to repeat string instructions (e.g., 0xF0, 0xF2, 0xF3, etc.), to provide section overrides (e.g., 0x2E, 0x36, 0x3E, 0x26, 0x64, 0x65, 0x2E, 0x3E, etc.), to perform bus lock operations, and/or to change operand (e.g., 0x66) and address sizes (e.g., 0x67). Certain instructions require a mandatory prefix (e.g., 0x66, 0xF2, 0xF3, etc.). Certain of these prefixes may be considered “legacy” prefixes. Other prefixes, one or more examples of which are detailed herein, indicate, and/or provide further capability, such as specifying particular registers, etc. The other prefixes typically follow the “legacy” prefixes.

The opcode field 1803 is used to at least partially define the operation to be performed upon a decoding of the instruction. In some examples, a primary opcode encoded in the opcode field 1803 is one, two, or three bytes in length. In other examples, a primary opcode can be a different length. An additional 3-bit opcode field is sometimes encoded in another field.

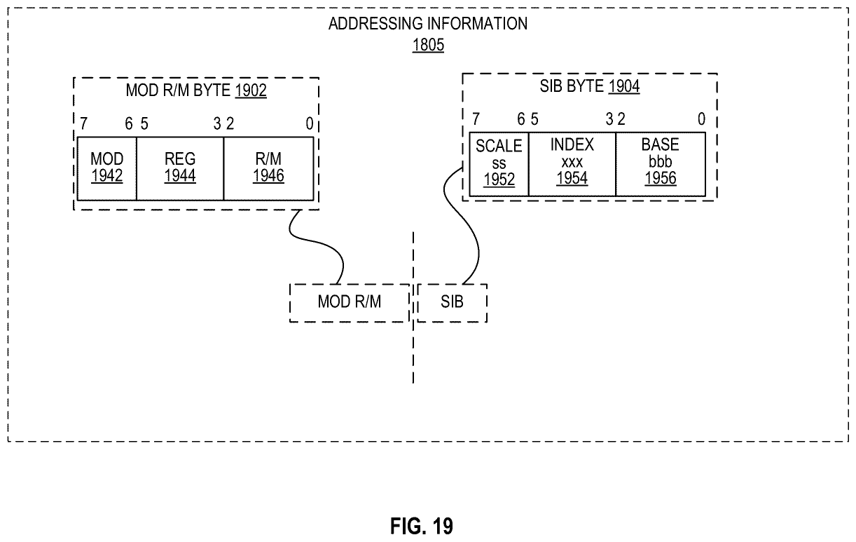

The addressing information field 1805 is used to address one or more operands of the instruction, such as a location in memory or one or more registers. FIG. 19 illustrates examples of the addressing information field 1805. In this illustration, an optional MOD R/M byte 1902 and an optional Scale, Index, Base (SIB) byte 1904 are shown. The MOD R/M byte 1902 and the SIB byte 1904 are used to encode up to two operands of an instruction, each of which is a direct register or effective memory address. Note that both of these fields are optional in that not all instructions include one or more of these fields. The MOD R/M byte 1902 includes a MOD field 1942, a register (reg) field 1944, and R/M field 1946.

The content of the MOD field 1942 distinguishes between memory access and non-memory access modes. In some examples, when the MOD field 1942 has a binary value of 11 (11b), a register-direct addressing mode is utilized, and otherwise a register-indirect addressing mode is used.

The register field 1944 may encode either the destination register operand or a source register operand or may encode an opcode extension and not be used to encode any instruction operand. The content of register field 1944, directly or through address generation, specifies the locations of a source or destination operand (either in a register or in memory). In some examples, the register field 1944 is supplemented with an additional bit from a prefix (e.g., prefix 1801) to allow for greater addressing.

The R/M field 1946 may be used to encode an instruction operand that references a memory address or may be used to encode either the destination register operand or a source register operand. Note the R/M field 1946 may be combined with the MOD field 1942 to dictate an addressing mode in some examples.

The SIB byte 1904 includes a scale field 1952, an index field 1954, and a base field 1956 to be used in the generation of an address. The scale field 1952 indicates a scaling factor. The index field 1954 specifies an index register to use. In some examples, the index field 1954 is supplemented with an additional bit from a prefix (e.g., prefix 1801) to allow for greater addressing. The base field 1956 specifies a base register to use. In some examples, the base field 1956 is supplemented with an additional bit from a prefix (e.g., prefix 1801) to allow for greater addressing. In practice, the content of the scale field 1952 allows for the scaling of the content of the index field 1954 for memory address generation (e.g., for address generation that uses 2^{scale}*index+base).

Some addressing forms utilize a displacement value to generate a memory address. For example, a memory address may be generated according to 2^{scale}*index+base+displacement, index*scale+displacement, r/m+displacement, instruction pointer (RIP/EIP)+displacement, register+displacement, etc. The displacement may be a 1-byte, 2-byte, 4-byte, etc. value. In some examples, the displacement field 1807 provides this value. Additionally, in some examples, a displacement factor usage is encoded in the MOD field of the addressing information field 1805 that indicates a compressed displacement scheme for which a displacement value is calculated and stored in the displacement field 1807.

In some examples, the immediate value field 1809 specifies an immediate value for the instruction. An immediate value may be encoded as a 1-byte value, a 2-byte value, a 4-byte value, etc.

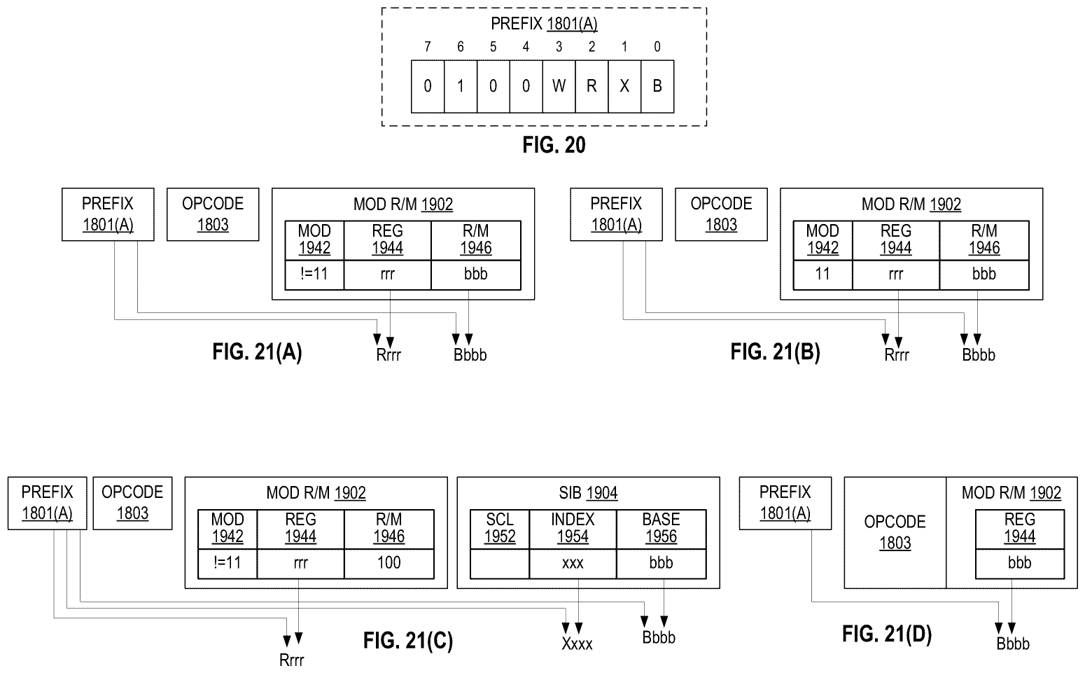

FIG. 20 illustrates examples of a first prefix 1801(A). In some examples, the first prefix 1801(A) is an example of a REX prefix. Instructions that use this prefix may specify general purpose registers, 64-bit packed data registers (e.g., single instruction, multiple data (SIMD) registers or vector registers), and/or control registers and debug registers (e.g., CR8-CR15 and DR8-DR15).

Instructions using the first prefix 1801(A) may specify up to three registers using 3-bit fields depending on the format: 1) using the reg field 1944 and the R/M field 1946 of the MOD R/M byte 1902; 2) using the MOD R/M byte 1902 with the SIB byte 1904 including using the reg field 1944 and the base field 1956 and index field 1954; or 3) using the register field of an opcode.

In the first prefix 1801(A), bit positions 7:4 are set as 0100. Bit position 3 (W) can be used to determine the operand size but may not solely determine operand width. As such, when W=0, the operand size is determined by a code segment descriptor (CS.D) and when W=1, the operand size is 64-bit.

Note that the addition of another bit allows for 16 (2⁴) registers to be addressed, whereas the MOD R/M reg field 1944 and MOD R/M R/M field 1946 alone can each only address 8 registers.

In the first prefix 1801(A), bit position 2 (R) may be an extension of the MOD R/M reg field 1944 and may be used to modify the MOD R/M reg field 1944 when that field encodes a general-purpose register, a 64-bit packed data register (e.g., a SSE register), or a control or debug register. R is ignored when MOD R/M byte 1902 specifies other registers or defines an extended opcode.

Bit position 1 (X) may modify the SIB byte index field 1954.

Bit position 0 (B) may modify the base in the MOD R/M R/M field 1946 or the SIB byte base field 1956; or it may modify the opcode register field used for accessing general purpose registers (e.g., general purpose registers 1725).

FIGS. 21(A)-(D) illustrate examples of how the R, X, and B fields of the first prefix 1801(A) are used. FIG. 21(A) illustrates R and B from the first prefix 1801(A) being used to extend the reg field 1944 and R/M field 1946 of the MOD R/M byte 1902 when the SIB byte 19 04 is not used for memory addressing. FIG. 21(B) illustrates R and B from the first prefix 1801 (A) being used to extend the reg field 1944 and R/M field 1946 of the MOD R/M byte 1902 when the SIB byte 19 04 is not used (register-register addressing). FIG. 21(C) illustrates R, X, and B from the first prefix 1801(A) being used to extend the reg field 1944 of the MOD R/M byte 1902 and the index field 1954 and base field 1956 when the SIB byte 19 04 being used for memory addressing. FIG. 21(D) illustrates B from the first prefix 1801 (A) being used to extend the reg field 1944 of the MOD R/M byte 1902 when a register is encoded in the opcode 1803.

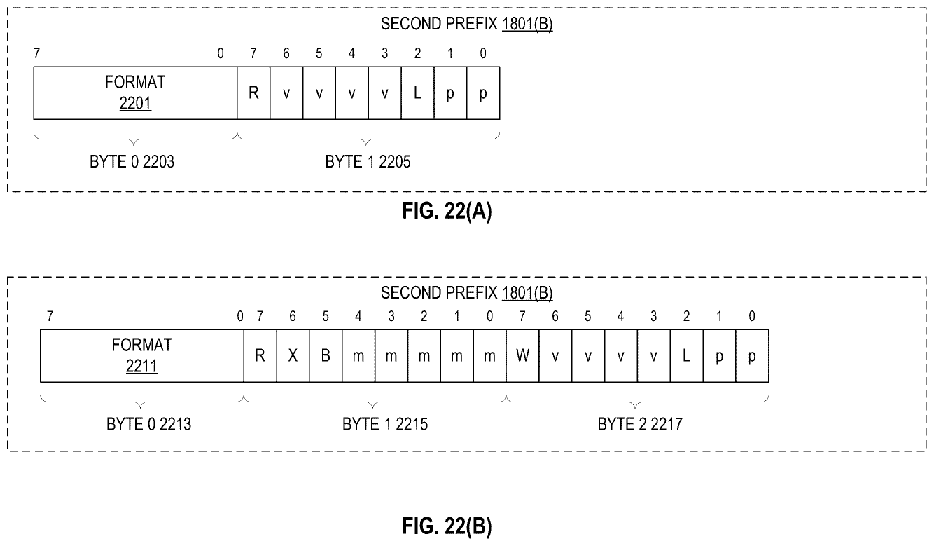

FIGS. 22(A)-(B) illustrate examples of a second prefix 1801(B). In some examples, the second prefix 1801(B) is an example of a VEX prefix. The second prefix 1801(B) encoding allows instructions to have more than two operands, and allows SIMD vector registers (e.g., vector/SIMD registers 1710) to be longer than 64-bits (e.g., 128-bit and 256-bit). The use of the second prefix 1801(B) provides for three-operand (or more) syntax. For example, previous two-operand instructions performed operations such as A=A+B, which overwrites a source operand. The use of the second prefix 1801(B) enables operands to perform nondestructive operations such as A=B+C.

In some examples, the second prefix 1801(B) comes in two forms—a two-byte form and a three-byte form. The two-byte second prefix 1801(B) is used mainly for 128-bit, scalar, and some 256-bit instructions; while the three-byte second prefix 1801(B) provides a compact replacement of the first prefix 1801(A) and 3-byte opcode instructions.

FIG. 22(A) illustrates examples of a two-byte form of the second prefix 1801(B). In one example, a format field 2201 (byte 0 2203) contains the value CSH. In one example, byte 1 2205 includes an “R” value in bit[7]. This value is the complement of the “R” value of the first prefix 1801(A). Bit[2] is used to dictate the length (L) of the vector (where a value of 0 is a scalar or 128-bit vector and a value of 1 is a 256-bit vector). Bits[1:0] provide opcode extensionality equivalent to some legacy prefixes (e.g., 00=no prefix, 01=66H, 10=F3H, and 11=F2H). Bits[6:3] shown as vvvv may be used to: 1) encode the first source register operand, specified in inverted (1s complement) form and valid for instructions with 2 or more source operands; 2) encode the destination register operand, specified in 1s complement form for certain vector shifts; or 3) not encode any operand, the field is reserved and should contain a certain value, such as 1111b.

Instructions that use this prefix may use the MOD R/M R/M field 1946 to encode the instruction operand that references a memory address or encode either the destination register operand or a source register operand.

Instructions that use this prefix may use the MOD R/M reg field 1944 to encode either the destination register operand or a source register operand, or to be treated as an opcode extension and not used to encode any instruction operand.

For instruction syntax that support four operands, vvvv, the MOD R/M R/M field 1946 and the MOD R/M reg field 1944 encode three of the four operands. Bits[7:4] of the immediate value field 1809 are then used to encode the third source register operand.

FIG. 22(B) illustrates examples of a three-byte form of the second prefix 1801(B). In one example, a format field 2211 (byte 0 2213) contains the value C4H. Byte 1 2215 includes in bits[7:5]“R,” “X,” and “B” which are the complements of the same values of the first prefix 1801(A). Bits[4:0] of byte 1 2215 (shown as mmmmm) include content to encode, as need, one or more implied leading opcode bytes. For example, 00001 implies a 0FH leading opcode, 00010 implies a 0F38H leading opcode, 00011 implies a 0F3AH leading opcode, etc.

Bit[7] of byte 2 2217 is used similar to W of the first prefix 1801(A) including helping to determine promotable operand sizes. Bit[2] is used to dictate the length (L) of the vector (where a value of 0 is a scalar or 128-bit vector and a value of 1 is a 256-bit vector). Bits[1:0] provide opcode extensionality equivalent to some legacy prefixes (e.g., 00=no prefix, 01=66H, 10=F3H, and 11=F2H). Bits[6:3], shown as vvvv, may be used to: 1) encode the first source register operand, specified in inverted (1s complement) form and valid for instructions with 2 or more source operands; 2) encode the destination register operand, specified in 1s complement form for certain vector shifts; or 3) not encode any operand, the field is reserved and should contain a certain value, such as 1111b.

Instructions that use this prefix may use the MOD R/M R/M field 1946 to encode the instruction operand that references a memory address or encode either the destination register operand or a source register operand.

Instructions that use this prefix may use the MOD R/M reg field 1944 to encode either the destination register operand or a source register operand, or to be treated as an opcode extension and not used to encode any instruction operand.

For instruction syntax that support four operands, vvvv, the MOD R/M R/M field 1946, and the MOD R/M reg field 1944 encode three of the four operands. Bits[7:4] of the immediate value field 1809 are then used to encode the third source register operand.

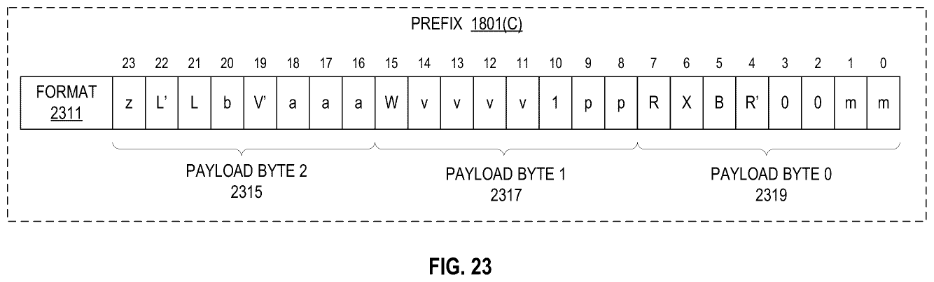

FIG. 23 illustrates examples of a third prefix 1801(C). In some examples, the third prefix 1801(C) is an example of an EVEX prefix. The third prefix 1801(C) is a four-byte prefix.

The third prefix 1801(C) can encode 32 vector registers (e.g., 128-bit, 256-bit, and 512-bit registers) in 64-bit mode. In some examples, instructions that utilize a writemask/opmask (see discussion of registers in a previous figure, such as FIG. 17) or predication utilize this prefix. Opmask register allow for conditional processing or selection control. Opmask instructions, whose source/destination operands are opmask registers and treat the content of an opmask register as a single value, are encoded using the second prefix 1801(B).

The third prefix 1801(C) may encode functionality that is specific to instruction classes (e.g., a packed instruction with “load+op” semantic can support embedded broadcast functionality, a floating-point instruction with rounding semantic can support static rounding functionality, a floating-point instruction with non-rounding arithmetic semantic can support “suppress all exceptions” functionality, etc.).

The first byte of the third prefix 1801(C) is a format field 2311 that has a value, in one example, of 62H. Subsequent bytes are referred to as payload bytes 2315-2319 and collectively form a 24-bit value of P[23:0] providing specific capability in the form of one or more fields (detailed herein).

In some examples, P[1:0] of payload byte 2319 are identical to the low two mm bits. P[3:2] are reserved in some examples. Bit P[4] (R′) allows access to the high 16 vector register set when combined with P[7] and the MOD R/M reg field 1944. P[6] can also provide access to a high 16 vector register when SIB-type addressing is not needed. P[7:5] consist of R, X, and B which are operand specifier modifier bits for vector register, general purpose register, memory addressing and allow access to the next set of 8 registers beyond the low 8 registers when combined with the MOD R/M register field 1944 and MOD R/M R/M field 1946. P[9:8] provide opcode extensionality equivalent to some legacy prefixes (e.g., 00=no prefix, 01=66H, 10=F3H, and 11=F2H). P[10] in some examples is a fixed value of 1. P[14:11], shown as vvvv, may be used to: 1) encode the first source register operand, specified in inverted (1s complement) form and valid for instructions with 2 or more source operands; 2) encode the destination register operand, specified in 1s complement form for certain vector shifts; or 3) not encode any operand, the field is reserved and should contain a certain value, such as 1111b.

P[15] is similar to W of the first prefix 1801(A) and second prefix 1811(B) and may serve as an opcode extension bit or operand size promotion.

P[18:16] specify the index of a register in the opmask (writemask) registers (e.g., writemask/predicate registers 1715). In one example, the specific value aaa=000 has a special behavior implying no opmask is used for the particular instruction (this may be implemented in a variety of ways including the use of a opmask hardwired to all ones or hardware that bypasses the masking hardware). When merging, vector masks allow any set of elements in the destination to be protected from updates during the execution of any operation (specified by the base operation and the augmentation operation); in other one example, preserving the old value of each element of the destination where the corresponding mask bit has a 0. In contrast, when zeroing vector masks allow any set of elements in the destination to be zeroed during the execution of any operation (specified by the base operation and the augmentation operation); in one example, an element of the destination is set to 0 when the corresponding mask bit has a 0 value. A subset of this functionality is the ability to control the vector length of the operation being performed (that is, the span of elements being modified, from the first to the last one); however, it is not necessary that the elements that are modified be consecutive. Thus, the opmask field allows for partial vector operations, including loads, stores, arithmetic, logical, etc. While examples are described in which the opmask field's content selects one of a number of opmask registers that contains the opmask to be used (and thus the opmask field's content indirectly identifies that masking to be performed), alternative examples instead or additional allow the mask write field's content to directly specify the masking to be performed.
P[19] can be combined with P[14:11] to encode a second source vector register in a non-destructive source syntax which can access an upper 16 vector registers using P[19].
P[20] encodes multiple functionalities, which differs across different classes of instructions and can affect the meaning of the vector length/rounding control specifier field (P[22:21]). P[23] indicates support for merging-writemasking (e.g., when set to 0) or support for zeroing and merging-writemasking (e.g., when set to 1).

Example examples of encoding of registers in instructions using the third prefix 1801(C) are detailed in the following tables.

TABLE 1
32-Register Support in 64-bit Mode

| | 4 | 3 | [2:0] | REG. TYPE | COMMON USAGES |
|---|---|---|---|---|---|
| REG | R′ | R | MOD R/M | GPR, Vector | Destination or Source |
| | | | reg | | |
| VVVV | V′ | vvv | | GPR, Vector | 2nd Source or Destination |
| RM | X | B | MOD R/M | GPR, Vector | 1st Source or Destination |
| | | | R/M | | |
| BASE | 0 | B | MOD R/M | GPR | Memory addressing |
| | | | R/M | | |
| INDEX | 0 | X | SIB.index | GPR | Memory addressing |
| VIDX | V′ | X | SIB.index | Vector | VSIB memory addressing |

TABLE 2
Encoding Register Specifiers in 32-bit Mode

| | [2:0] | REG. TYPE | COMMON USAGES |
|---|---|---|---|
| REG | MOD R/M reg | GPR, Vector | Destination or Source |
| VVVV | vvvv | GPR, Vector | 2^{nd} Source or Destination |
| RM | MOD R/M R/M | GPR, Vector | 1^{st} Source or Destination |
| BASE | MOD R/M R/M | GPR | Memory addressing |
| INDEX | SIB.index | GPR | Memory addressing |
| VIDX | SIB.index | Vector | VSIB memory addressing |

TABLE 3
Opmask Register Specifier Encoding

| | [2:0] | REG. TYPE | COMMON USAGES |
|---|---|---|---|
| REG | MOD R/M Reg | k0-k7 | Source |
| VVVV | vvvv | k0-k7 | 2^{nd} Source |
| RM | MOD R/M R/M | k0-k7 | 1^{st} Source |
| {k1} | aaa | k0-k7 | Opmask |

Program code may be applied to input information to perform the functions described herein and generate output information. The output information may be applied to one or more output devices, in known fashion. For purposes of this application, a processing system includes any system that has a processor, such as, for example, a digital signal processor (DSP), a microcontroller, an application specific integrated circuit (ASIC), a field programmable gate array (FPGA), a microprocessor, or any combination thereof.

The program code may be implemented in a high-level procedural or object-oriented programming language to communicate with a processing system. The program code may also be implemented in assembly or machine language, if desired. In fact, the mechanisms described herein are not limited in scope to any particular programming language. In any case, the language may be a compiled or interpreted language.

Examples of the mechanisms disclosed herein may be implemented in hardware, software, firmware, or a combination of such implementation approaches. Examples may be implemented as computer programs or program code executing on programmable systems comprising at least one processor, a storage system (including volatile and non-volatile memory and/or storage elements), at least one input device, and at least one output device.

One or more aspects of at least one example may be implemented by representative instructions stored on a machine-readable medium which represents various logic within the processor, which when read by a machine causes the machine to fabricate logic to perform the techniques described herein. Such representations, known as “intellectual property (IP) cores” may be stored on a tangible, machine readable medium and supplied to various customers or manufacturing facilities to load into the fabrication machines that make the logic or processor.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, examples also include non-transitory, tangible machine-readable media containing instructions or containing design data, such as Hardware Description Language (HDL), which defines structures, circuits, apparatuses, processors and/or system features described herein. Such examples may also be referred to as program products.

Emulation (including binary translation, code morphing, etc.).

In some cases, an instruction converter may be used to convert an instruction from a source instruction set architecture to a target instruction set architecture. For example, the instruction converter may translate (e.g., using static binary translation, dynamic binary translation including dynamic compilation), morph, emulate, or otherwise convert an instruction to one or more other instructions to be processed by the core. The instruction converter may be implemented in software, hardware, firmware, or a combination thereof. The instruction converter may be on processor, off processor, or part on and part off processor.

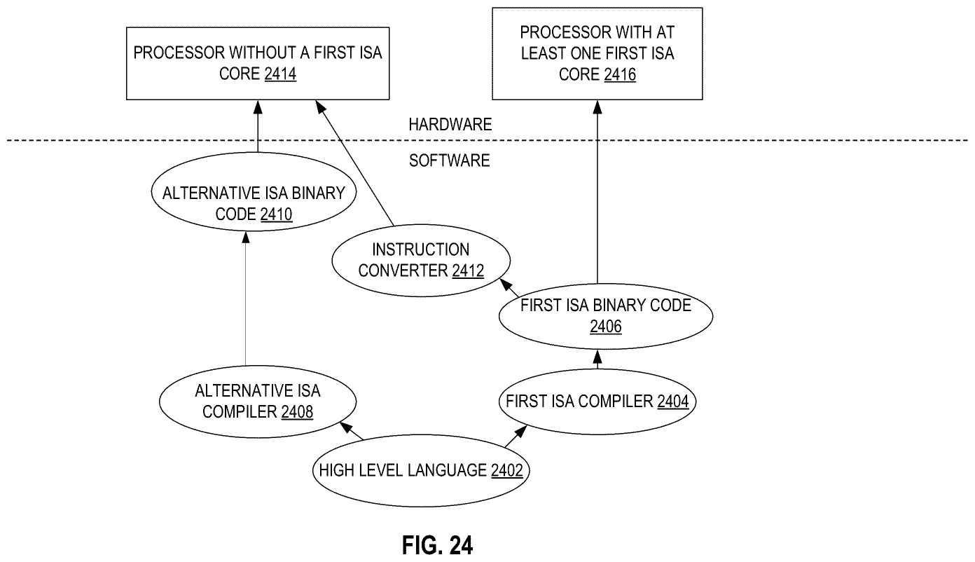

FIG. 24 is a block diagram illustrating the use of a software instruction converter to convert binary instructions in a source ISA to binary instructions in a target ISA according to examples. In the illustrated example, the instruction converter is a software instruction converter, although alternatively the instruction converter may be implemented in software, firmware, hardware, or various combinations thereof. FIG. 24 shows a program in a high-level language 2402 may be compiled using a first ISA compiler 2404 to generate first ISA binary code 2406 that may be natively executed by a processor with at least one first ISA core 2416. The processor with at least one first ISA core 2416 represents any processor that can perform substantially the same functions as an Intel® processor with at least one first ISA core by compatibly executing or otherwise processing (1) a substantial portion of the first ISA or (2) object code versions of applications or other software targeted to run on an Intel processor with at least one first ISA core, in order to achieve substantially the same result as a processor with at least one first ISA core. The first ISA compiler 2404 represents a compiler that is operable to generate first ISA binary code 2406 (e.g., object code) that can, with or without additional linkage processing, be executed on the processor with at least one first ISA core 2416. Similarly, FIG. 24 shows the program in the high-level language 2402 may be compiled using an alternative ISA compiler 2408 to generate alternative ISA binary code 2410 that may be natively executed by a processor without a first ISA core 2414. The instruction converter 2412 is used to convert the first ISA binary code 2406 into code that may be natively executed by the processor without a first ISA core 2414. This converted code is not necessarily to be the same as the alternative ISA binary code 2410; however, the converted code will accomplish the general operation and be made up of instructions from the alternative ISA. Thus, the instruction converter 2412 represents software, firmware, hardware, or a combination thereof that, through emulation, simulation or any other process, allows a processor or other electronic device that does not have a first ISA processor or core to execute the first ISA binary code 2406.

References to “one example,” “an example,” etc., indicate that the example described may include a particular feature, structure, or characteristic, but every example may not necessarily include the particular feature, structure, or characteristic. Moreover, such phrases are not necessarily referring to the same example. Further, when a particular feature, structure, or characteristic is described in connection with an example, it is submitted that it is within the knowledge of one skilled in the art to affect such feature, structure, or characteristic in connection with other examples whether or not explicitly described.

Examples include, but are not limited to:
1. An apparatus comprising:
   execution circuitry configured to execute trusted execution environment (TEE) entry instructions;
   TEE logic to support TEE usage, wherein the TEE logic is configured to at least in part:
      determine that a TEE feature is supported based at least on a value of a bit position in a data structure; and
      not allow a TEE entry instruction to access to a TEE when the bit position of the data structure is reserved.
2. The apparatus of example 1, wherein the TEE logic is microcode.
3. The apparatus of example 1, wherein the TEE logic software stored in memory.
4. The apparatus of example 1, wherein the data structure is a thread control structure.
5. The apparatus of example 1, wherein the data structure is an attributes field.
6. The apparatus of example 1, wherein the data structure is a feature-disabled structure.
7. The apparatus of examples 1-6, wherein the data structure is to be updated upon a microcode patch rollback to make the bit position reserved.
8. The apparatus of examples 1-6, wherein the data structure is to be updated upon a microcode update to make the bit position indicate support for the TEE feature.
9. A system comprising:
   memory store a trusted execution environment (TEE);
   execution circuitry configured to execute aTEE entry instructions; and
   TEE logic to support TEE usage, wherein the TEE logic is configured to at least in part:
   determine that a TEE feature is supported based at least on a value of a bit position in a data structure; and
   not allow a TEE entry instruction to access to a TEE when the bit position of the data structure is reserved.
10. The system of example 9, wherein the TEE logic is microcode.
11. The system of example 9, wherein the TEE logic software stored in the memory.
12. The system of example 9, wherein the data structure is a thread control structure.
13. The system of example 9, wherein the data structure is an attributes field.
14. The system of example 9, wherein the data structure is a feature-disabled structure. The system of any of examples 9-14, wherein the data structure is to be updated upon a microcode patch rollback to make the bit position reserved.
16. The system of any of examples 9-14, wherein the data structure is to be updated upon a microcode update to make the bit position indicate support for the TEE feature.
17. The system of any of examples 9-16, wherein the TEE is to store user application code.
18. The system of example 9, wherein the memory is to store a feature-disabled structure.
19. The system of example 9, wherein the memory is to store a feature-enabled structure.
20. The system of any of examples 9-19, wherein the data structure further comprises a plurality of reserved bits.

Moreover, in the various examples described above, unless specifically noted otherwise, disjunctive language such as the phrase “at least one of A, B, or C” or “A, B, and/or C” is intended to be understood to mean either A, B, or C, or any combination thereof (i.e. A and B, A and C, B and C, and A, B and C).

The specification and drawings are, accordingly, to be regarded in an illustrative rather than a restrictive sense. It will, however, be evident that various modifications and changes may be made thereunto without departing from the broader spirit and scope of the disclosure as set forth in the claims.

What is claimed is:

1. An apparatus comprising:
execution circuitry configured to execute trusted execution environment (TEE) entry instructions;
TEE logic to support TEE usage, wherein the TEE logic is configured to at least in part:
determine that a TEE feature is supported based at least on a value of a bit position in a data structure; and
not allow a TEE entry instruction to access to a TEE when the bit position of the data structure is reserved.

2. The apparatus of claim 1, wherein the TEE logic is microcode.

3. The apparatus of claim 1, wherein the TEE logic software stored in memory.

4. The apparatus of claim 1, wherein the data structure is a thread control structure.

5. The apparatus of claim 1, wherein the data structure is an attributes field.

6. The apparatus of claim 1, wherein the data structure is a feature-disabled structure.

7. The apparatus of claim 1, wherein the data structure is to be updated upon a microcode patch rollback to make the bit position reserved.

8. The apparatus of claim 1, wherein the data structure is to be updated upon a microcode update to make the bit position indicate support for the TEE feature.

9. A system comprising:
memory store a trusted execution environment (TEE);
execution circuitry configured to execute aTEE entry instructions; and
TEE logic to support TEE usage, wherein the TEE logic is configured to at least in part:
determine that a TEE feature is supported based at least on a value of a bit position in a data structure; and
not allow a TEE entry instruction to access to a TEE when the bit position of the data structure is reserved. The system of claim 9, wherein the TEE logic is microcode.

11. The system of claim 9, wherein the TEE logic software stored in the memory.

12. The system of claim 9, wherein the data structure is a thread control structure.

13. The system of claim 9, wherein the data structure is an attributes field.

14. The system of claim 9, wherein the data structure is a feature-disabled structure.

15. The system of claim 9, wherein the data structure is to be updated upon a microcode patch rollback to make the bit position reserved.

16. The system of claim 9, wherein the data structure is to be updated upon a microcode update to make the bit position indicate support for the TEE feature.

17. The system of claim 9, wherein the TEE is to store user application code.

18. The system of claim 9, wherein the memory is to store a feature-disabled structure.

19. The system of claim 9, wherein the memory is to store a feature-enabled structure.

20. The system of claim 9, wherein the data structure further comprises a plurality of reserved bits.
